(19) United States
(12) Patent Application Publication
(10) Pub. No.: US 2008/0071540 A1
(43) Pub. Date: Mar. 20, 2008

(54) Speech recognition method for robot under motor noise thereof

(75) Inventors: Mikio Nakano, Tokyo (JP); Kazuhiro Nakadai, Tokyo (JP); Hiroshi Tsujino, Fujimi-shi (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/900,725

(22) Filed: Sep. 12, 2007

Related U.S. Application Data
(60) Provisional application No. 60/844,256, filed on Sep. 13, 2006.
(60) Provisional application No. 60/859,123, filed on Nov. 15, 2006.

(51) Int. Cl. G10L 15/00

(52) U.S. Cl. 704/251; 704/E15.001

(57) ABSTRACT

A robot that recognizes speech of a person while performing predetermined motions or gestures, the robot includes: a drive unit executing the motions or gestures; a determination unit determining one of the motions or gestures being executed; a speech recognition unit having at least two recognition algorithms including a multi-condition training algorithm; and a switch unit selecting one of the recognition algorithms depending on one of the motions or gestures determined.

### CROSS REFERENCE TO RELATED APPLICATIONS

This application claims benefit from U.S. Provisional application Ser. No. 60/844,256, filed Sep. 13, 2006, and U.S. Provisional application Ser. No. 60/859,123, filed Nov. 15, 2006, the contents of which are incorporated herein by reference.

### BACKGROUND OF THE INVENTION

1. Field of the Invention

The present invention relates to a speech recognition method, in particular, relates to a speech recognition method for a robot under motor noise of the robot.

2. Description of the Related Art

Automatic speech recognition (ASR) is essential for a robot to communicate with people. To make human-robot communication natural, it is necessary for the robot to recognize speech even while it is moving and performing gestures. For example, a robot's gesture is considered to play a crucial role in natural human-robot communication. In addition, robots are expected to perform tasks by physical actions to make presentation. If the robot can recognize human interruption speech while it is executing physical actions or making a presentation with gestures, it would make the robot more useful.

However, ASR by robot is difficult, because motor noise is inevitably generated while in motion. In addition, the power of the motor noise is stronger than that of target speech because the motors are closer to the robot's microphones. The motor noise changes irregularly so we cannot obtain satisfactory performance from ASR using a conventional noise adaptation method. So far, a lot of noise-robust ASR techniques have been proposed; however, there has not been much research on speech recognition under noise of robot motion.

A common technique is multi-condition training. It trains the acoustic model on speech data to which noises are added. This technique improves ASR performance when an input signal includes the noises added in training the acoustic model. This has a characteristic that it is easy to cope with stationary noises rather than non-stationary ones. Therefore, we expect that this is effective for speech recognition in performing a motion or a gesture that produces stationary noises.

MLLR also improves the robustness of ASR by using an adaptation technique with the affine transform. MLLR adaptation for a multi-condition acoustic model is more effective in speech recognition than that for an acoustic model trained on clean speech, because the performance of speech recognition using the multi-condition acoustic model is originally higher. Actually, we confirmed this through a preliminary experiment. Preparing multi-condition acoustic models for all kinds of motor noises without using MLLR would be time-consuming. In addition, it might suffer from overfitting.

Missing Feature Theory (MFT) (refer to Non-patent document 1: J. Barker, M. Cooke and P. Green, “Robust ASR based on clean speech models: An evaluation of missing data techniques for connected digit recognition in noise,” Proc. EUROSPEECH 2001, 2001, vol. 1, pp. 213-216) is proposed to cope with noisy speech input. When there are noises, some areas in the spectro-temporal space of speech are unreliable as acoustic features. Ignoring reliable areas or estimating features in the unreliable parts using reliable areas make it possible to perform noise-robust speech recognition. As a similar approach, multi-band ASR has been proposed. This method uses HMMs for each sub-band, and obtains integrated likelihood by assigning smaller weights to unreliable sub-bands. In this application, when the term MFT is used, it includes the multi-band ASR method.

MFT-based methods show high noise-robustness against both stationary and non-stationary noises when the reliability of acoustic features is estimated correctly. One of the main issues in applying them to ASR is how to estimate the reliability of input acoustic features correctly. Because the signal-to-noise ratio (SNR) and the distortion of input acoustic features are usually unknown, the reliability of the input acoustic features cannot be estimated. However, because pre-recorded noises are available in recognition, the reliability estimation of the input acoustic features is easier even when the noise power is high. Therefore, we think that MFT is more suitable to deal with the non-stationary noises from the robot's motors.

Spectral Subtraction (SS) is one of the common methods to suppress noises. Applying SS to cope with the robot's own motor noise has been proposed. In this approach, the motor noise from the robot's joint angles was estimated with a neural network, and SS was performed using the estimated noise. One problem with this approach is that ASR performance degraded when the noise is not well-estimated. In addition, when the noise estimation fails, the degradation is worse than that in the case of MFT approaches, because SS modifies acoustic feature directly. Since the same types of motions do not always generate the exactly-identical motor noises, it is difficult to estimate the motor noises with sufficient accuracy for SS to cope with noises properly. Therefore, the SS-based method is not suitable for the robot.

When multiple microphones are available, it is possible to use speech separation techniques to extract the target speech such as Beam Forming (BF), Independent Component Analysis (ICA), and Geometric Source Separation (GSS). BF is a common method to separate sound sources by using multiple microphones. However, in the cases of conventional BF approaches, separate speech is distorted by noises and inter-channel leak energy. This degrades ASR performance. Some BF methods with less distortion such as adaptive beam forming require a lot of computational power, which makes real-time sound source separation difficult. ICA is one of the best methods for sound source separation. It assumes that sound sources are mutually independent and the number of sound sources equals to that of microphones. These assumptions are, however, too strong to separate sound sources in the real world. In addition, it has some other problems referred to as permutation problem and scaling problem that are hard to solve. In GSS, the limitation of the relationship between the number of sound sources and microphones is relaxed. It can separate up to N−1 sound sources where N is the number of microphones by introducing “geometric constraints” obtained from the locations of sound sources and microphones. A robot audition system is known that recognized simultaneous speech by combining of GSS and MFT-based ASR. The effectiveness of GSS has been shown as well as MFT-based ASR with automatic reliability estimation using the inter-channel leakage energy. However, in GSS, errors in geometric constraints affect the performance badly, while microphone and sound source locations generally include some errors in measurement and localization.

Multi-channel approaches are effective when sound source separation works properly. However, every approach generates separation errors more or less. In addition, the size of a total system tends to be large. This means that the number of parameters for the system increases and more computational power is required by the system. Because the room and computational power available for a robot are limited, these are serious problems when being applied to a robot. Therefore, we focus on single channel approaches in this application.

In the future, humanoids are expected to be partners with humans. To facilitate this partnership the humanoid should be able to listen to the user's speech by using its own microphones. It is not realistic to assume that the user always wears a headset. As we develop such a humanoid, “noise” generated by its actuators is a real problem. The humanoid is basically a highly redundant system, so it includes a lot of motors as well as cooling fans for humanoid-embedded processors required to achieve human-like behaviors autonomously. These humanlike behaviors are effective in making rich human-humanoid interactions. For example, a humanoid's gesture is considered to play a crucial role in natural human-humanoid communication. It is helpful in communicating with people for the humanoid to perform tasks and make presentations accompanied by physical actions. These motions, however, require high torque and high power motors, and fans which are capable of high rpms to cool the powerful CPUs. This naturally leads to loud noises. Furthermore, the actuators are closer to microphones embedded in the humanoid than the target speech source. Because of the close proximity of these noises sound signals captured with the microphones have a low signal-to-noise ratio (SNR) which can be less than 0 dB. In addition, the motor noises are not constant, resulting in an input SNR that changes dynamically. These factors make it difficult for the humanoid to recognize human speech while in motion. Most researchers working on human-humanoid communication tend to avoid this problem by wearing a headset to input a voice command instead of using the humanoid's own microphones. Some researchers are trying to use humanoid-embedded microphones for speech recognition. However, they deal with stationary noises, that is, they assume that the humanoid is stationary with respect to speech recognition.

In advanced researches for ASR so far, various methods for improving robustness against various noises have been proposed. Training of acoustic models by the multi-condition training is one of the most effective methods. In this method, because voices that pre-include noises are used for training of the acoustic models, the performance is excellent if the noises are known noises. However, in loud noise environment, it is impossible to distinguish utterance periods from non-utterance periods. Moreover, an effective training can be expected with respect to stationary noises; however, not so much effectiveness can be expected with respect to irregular noises. Therefore, the performance of this method is limited in loud noise environment.

MLLR (Maximum-Likelihood Linear Regression) is an approach in which an acoustic model is adapted to noises by using the affine transform. In this method, the acoustic model is adapted to noises or speakers in a recognition environment which is different from that during the training. The MLLR is an effective method; however, not so much effectiveness can be expected in an extremely loud noise environment or with respect to irregular noises.

As discussed above, in conventional ASR, many researches have been carried out for adapting the acoustic model to noises. This is because it is easier to improve the performance by adapting the acoustic model to noises than by taking measures in which noises are subtracted from the input signals. However, in the case of ASR in a robot, it is necessary to recognize speeches in loud noise environment whose noise level is higher (the SNR (signal-to-noise ratio) may be as small as 0 dB or smaller) than that expected in conventional ASR. In such a loud noise environment, when the acoustic model is adapted to noises, the original signals are merely retained, and it is impossible to carry out ASR. Accordingly, it is necessary to develop measures to suppress noises.

In the case of ASR in a robot, sound source separation has been often carried out as a pre-processing by using a microphone array. To this end, the Beam Forming (BF), the Independent Component Analysis (ICA), and the Geometric Source Separation (GSS) have been proposed. The BF is one of the generic sound source separation methods; however, the drawback is that distortion is produced in the speech signals by the sound source separation. An adaptive BF has been proposed for improvement; however, the drawback is that a lot of computational power is required. The ICA is effective because it is possible to carry out separation by only assuming independency of the sound sources; however, such an assumption is not satisfied frequently in a real environment, and a problem of permutation is experienced such that the separation signals have to be rearranged so that the separation signals at respective frequencies correspond to the identical sound source. The GSS method is an intermediate method between the BF and the ICA. In the GSS method, sound separation is carried out based on the relationship between the microphone and sound source locations and the sound source; however, it is difficult to accurately determine the locations, which adversely affects the sound separation performance.

Other than a motion noise, an environmental noise is one of the noises that adversely affect the ASR performance. Because the environmental noise is not stable, and even information with regard to sound source locations and the number of sound sources is not provided, it is necessary, for estimation of the noise, to use a method in which a microphone array is used. However, because the motion noise discussed in the present application is generated by a robot itself, and the robot can obtain information with regard to the motion produced by itself, it is possible to estimate the motion noise. Therefore, without improving robustness against noises by using a lot of information such as from the microphone array, it is possible to carry out an effective adaptation by only using less information.

Similarly, there is also a known approach to dealing with motion noise by using a single microphone for adaptation to noise and Spectral Subtraction (SS) method. In conventional SS method, stationary noise is estimated by using a non-utterance period or the like, and speech signals are extracted by subtracting the estimated noise component in the spectrum region. An SS method has been used in reducing motion noise of AIBO®. More specifically, the ASR performance in simulation is reported by training estimated noise in a neutral network to which articulation angle and position information is input, and by estimating noise signals to be subtracted in the SS method using the result of training. However, because the performance in a real environment is not mentioned in this report, it is uncertain how well the performance is in an environment with reverberation, and whether the performance is better than that of a method in which an acoustic model obtained by multi-condition training is used. Moreover, it is believed that the SS method is effective with respect to stationary noise; however, the SS method is not effective with respect to irregular noise because distortion may be produced.

A known method that is effective with respect to irregular noise uses the Missing Feature Theory (MFT). The MFT is an approach in which only a portion of speech signals that does not include noise and distortion is used for ASR. The other portion with low reliability is masked, and is not used for ASR. The MFT is classified into two, one is a strict MFT in which a mask is just used or not used, and the other is a broad MFT in which a mask is adjusted in accordance with the magnitude of reliability. The MFT in this application means the broad MFT. As a related research, a multi-band ASR is known in which a weighting factor is used. In the multi-band ASR with a weighting factor, a frequency band with low reliability is provided with a small weighting factor, and a frequency band with high reliability is provided with a large weighting factor, and thus reliability is reflected on the likelihood for ASR. In the method using the MFT, if the reliability is accurately estimated, the ASR performance is significantly improved when compared with the other noise adaptation methods. It is necessary to estimate the noise in order to accurately estimating the reliability; however, it is as difficult as ASR to estimate the noise in an invisible manner, which is a problem. In conventional ASR, the MFT has merely been effectively used because estimation of reliability is very difficult. However, because the motion noise of a robot dealt with in the present application can be easily estimated, the MFT can be effectively utilized.

### SUMMARY OF THE INVENTION

One of the important differences between environmental noises and robot motor noise is that a robot can estimate its motor noise because it knows what type of motion and gesture it is performing. Each kind of robot motion or gesture produces almost the same noise every time it is performed. By recording the motion and gesture noise in advance, the profile of the noise can be easily estimated based on the motion and gesture.

By using this theory, we introduce a new method for ASR under robot motor noise. Our method is based on three techniques, namely, multi-condition training, maximum-likelihood linear regression (MLLR), and missing feature theory (MFT) (refer to Non-patent document 1). These methods can utilize pre-recorded noises as will be described in detail below.

Since each of these techniques has advantages and disadvantages, whether it is effective depends on the types of motion and gesture. Thus, just combining these three techniques would not be effective for speech recognition under noises of all types of motion and gestures. We therefore propose to selectively use those methods according to the types of motion and motor noises. The result of an experiment of isolated word recognition under a variety of motion and gesture noises suggested the effectiveness of this approach.

One of the important differences between environmental noises and humanoid motor noises is that the humanoid can estimate its motor noises because it knows what type of motion or gesture it is performing. Each kind of motion or gesture produces a similar noise pattern every time it is performed. So, by recording the motion and gesture noises in advance, a motor noise can be easily estimated from the information on the corresponding motion or gesture.

In this application, we propose a new method to improve Automatic Speech Recognition (ASR) for a humanoid with motor noises by utilizing information about the humanoid's motion/gesture. This method consists of two stages; noise suppression suitable for ASR, and ASR based on the Missing Feature Theory (MFT) which improves ASR by masking unreliable acoustic features in an input sound (refer to Non-patent document 1). The motion/gesture information is used for estimating reliability of acoustic features for MFT. The result of the experiment on isolated word recognition under the condition where there exist a variety of motion and gesture noises supports the effectiveness of our proposed method.

So far, many noise-robust ASR techniques have been proposed. Generally, they fall into three categories; noise-robust acoustic models, decoder modification, and preprocessing. This section introduces these techniques and discusses which techniques are suitable for ASR under humanoid motor noises.

A. Noise-Robust Acoustic Model

A common technique is the multi-condition training. It trains the acoustic model on speech data to which noises are added. This technique improves ASR performance when an input signal includes the noises added in training acoustic model. However, speech data with all kinds of motor noises are necessary to train an acoustic model. Furthermore, it is time consuming and might suffer from overfitting.

Maximum-Likelihood Linear Regression (MLLR) also improves the robustness of ASR by using an adaptation technique with the affine transform. It is less time-consuming than multi-condition training in terms of calculation. However, the cost of data preparation is the same as with multi-condition training. A large amount of speech data with motor noises is required to cope with the many different motor noises.

B. Decoder Modification

One approach to improving noise-robustness by modifying the ASR decoder is Missing Feature Theory (MFT) (refer to Non-patent document 1). When noises exist, some areas in the spectro-temporal space of speech are unreliable as acoustic features. In MFT, such unreliable acoustic features are masked and only reliable ones are used for likelihood calculation in the ASR decoder. So, this process requires some modifications to the ASR decoder. In a similar approach, multi-band ASR has been proposed. This method uses HMMs for each sub-band, and obtains integrated likelihood by assigning smaller weights to unreliable sub-bands. In this application, when we use the term MFT, it can indicate both MFT and multi-band ASR.

MFT-based methods show high noise-robustness against both stationary and non-stationary noises when the reliability of acoustic features is estimated correctly. The main issue in applying them to ASR is how to estimate the reliability of input acoustic features correctly. Because the SNR and the distortion of input acoustic features are usually unknown, the reliability of the input acoustic features cannot be estimated. However, because pre-recorded noises are available in recognition, the reliability estimation of the input acoustic features is easier even when noise power is high. So, we think that MFT is more suitable for dealing with the non-stationary noises from the humanoid's motors.

C. Preprocessing

Preprocessing is performed to improve the SNR of the input speech signals. There are two common approaches—single channel and multi-channel approaches.

Spectral Subtraction (SS) is one of the common methods to suppress noises. Application of SS to cope with the humanoid's own motor noise has been proposed. In this approach, the motor noise from the humanoid's joint angles was estimated with a neural network, and SS was performed using this estimated noise. One problem with this approach is that ASR's performance degraded when the noise was not well-estimated. In addition, when the noise estimation fails, the degradation is worse than that in the case of MFT approaches, because SS modifies acoustic features directly. Since the same types of motions do not always generate identical motor noises, it is difficult to estimate the motor noises well enough for SS to cope with noises properly. So, the SS-based method is not suitable for the humanoid.

As another noise suppression technique, adaptive noise suppression based on a kind of spectral subtraction has been known. This method adaptively estimates a probability of speech existence based on the spectral power of a monaural input sound. According to this probability, noises included in the input are suppressed. Generally, while spectral subtraction makes musical noises and some distortions, but the noise-suppressed signal using this method includes less musical noises and distortion, because it takes temporal and spectral continuities into account.

Noise cancellation by using an internal microphone located close to the noise source has been known. However, this approach has the problem of deploying microphones for noise cancellation in the case of a humanoid, because a humanoid has many degrees of freedom that produce, a lot of noise sources, and their locations change due to gestures and walking.

When multiple microphones are available, it is possible to use speech separation techniques to extract the target speech such as Beam Forming (BF), Independent Component Analysis (ICA), and Geometric Source Separation (GSS). BF is a common method to separate sound sources by using multiple microphones. However, in the cases of conventional BF approaches, separate speech is distorted by noises and inter-channel leak energy. This degrades ASR performance. Some BF methods with less distortion such as adaptive beam forming require a lot of computational power, which makes real-time sound source separation difficult. ICA is one of the best methods for sound source separation. It assumes that sound sources are mutually independent and the number of sound sources is equal to the number of microphones. These assumptions are, however, beyond the real world capability to separate sound sources. In addition, ICA has some other problems, for example a permutation problem and a scaling problem that are hard to solve. In GSS, the limitation of the relationship between the numbers of sound sources and microphones is relaxed. It can separate up to N−1 sound sources where N is the number of microphones, by introducing “geometric constraints” obtained from the locations of sound sources and microphones. A humanoid audition system that recognized simultaneous speech by the combination of GSS and MFT-based ASR has been known. The effectiveness of GSS has been shown as well as MFT-based ASR with automatic reliability estimation using the inter-channel leakage energy. However, in GSS, errors in geometric constraints adversely affect the performance, while microphone and sound source locations generally include some errors in measurement and localization.

Multi-channel approaches are effective when the sound source separation works properly. However, every approach more or less generates separation errors. In addition, the total system tends to be complicated. This means that the number of parameters for the system increases and more computational power is required by the system. Because the space and computational power a humanoid can provide is limited, these can be difficult problems.

Therefore, in this application, we focus on single channel approaches. Consequently, we decided to use noise suppression for preprocessing, and MFT (refer to Non-patent document 1) for decoder modification. We did not use noise-robust acoustic model training techniques such as multi-condition training and MLLR explicitly. However, the acoustic models we used in this work assume that white noise is added to speech signals. So, we trained the acoustic models on white-noise added speech data. In this sense, we use noise-robust acoustic models.

In the present application, first, a noise suppression process is applied to the input signals. Such a noise suppression process is essential because the SNR is small in an environment with motion noise. Next, a white noise is overlaid in order to flatten the component remaining after subtracting the noise through the noise suppression process. It is believed that distortion in the speech signal due to the noise suppression process is small in an environment with a large SNR; however, distortion due to the noise suppression process is large in an environment with a small SNR, and the ASR performance may be degraded due to the noise suppression process. By the noise suppression process, most of the stationary noise such as motor noise can be suppressed; however, adaptation to irregular noise component due to motion may not be sufficient. To solve this problem, ASR with the MFT is carried out. The estimated motion noise is used to produce a mask in the MFT, and a portion with much noise is treated as having low reliability so that contribution thereof to ASR is made small.

The present invention provides a robot that recognizes speech of a person while performing predetermined motions or gestures, the robot including: a drive unit executing the motions or gestures; a determination unit determining one of the motions or gestures being executed; a speech recognition unit having at least two recognition algorithms including a multi-condition training algorithm; and a switch unit selecting one of the recognition algorithms depending on one of the motions or gestures determined.

In the above robot, the recognition algorithms may include a maximum-likelihood linear regression (MLLR).

In the above robot, the recognition algorithms may include a missing feature theory (MFT).

The robot may further include a noise template retention unit pre-recording noise that is generated during execution of the predetermined motions or gestures, producing a noise template, and retaining the noise template, wherein the noise template is applied to one of the recognition algorithms selected.

The robot may further include: a pre-processing unit suppressing noise included in an input signal (e.g., Spectrum Subtraction in an embodiment), and sending out an output; and a noise addition unit adding white noise to the output from the pre-processing unit. In this case, robustness with respect to irregular noise is improved.

### BRIEF DESCRIPTION OF THE DRAWINGS

FIG. 1 is a block diagram of a speech recognition method for a robot in a first embodiment of the present invention.

FIG. 2 is a schematic diagram illustrating selection of robust ASR technique depending on the types of noise in the first embodiment of the present invention.

FIG. 3 is a block diagram of a speech recognition method for a robot in a second embodiment of the present invention.

FIGS. 4A and 4B are schematic diagrams illustrating an example of perceptual closure in Gestalt psychology, in particular, three fragments do not organiza in FIG. 4A, and occlusion information halps organization in FIG. 4B.

FIG. 5 is a block diagram of noise adaptation method in a third embodiment of the present invention.

### DESCRIPTION OF THE PREFERRED EMBODIMENTS

### First Embodiment

(Selective Application of Noise-Robust ASR Techniques)

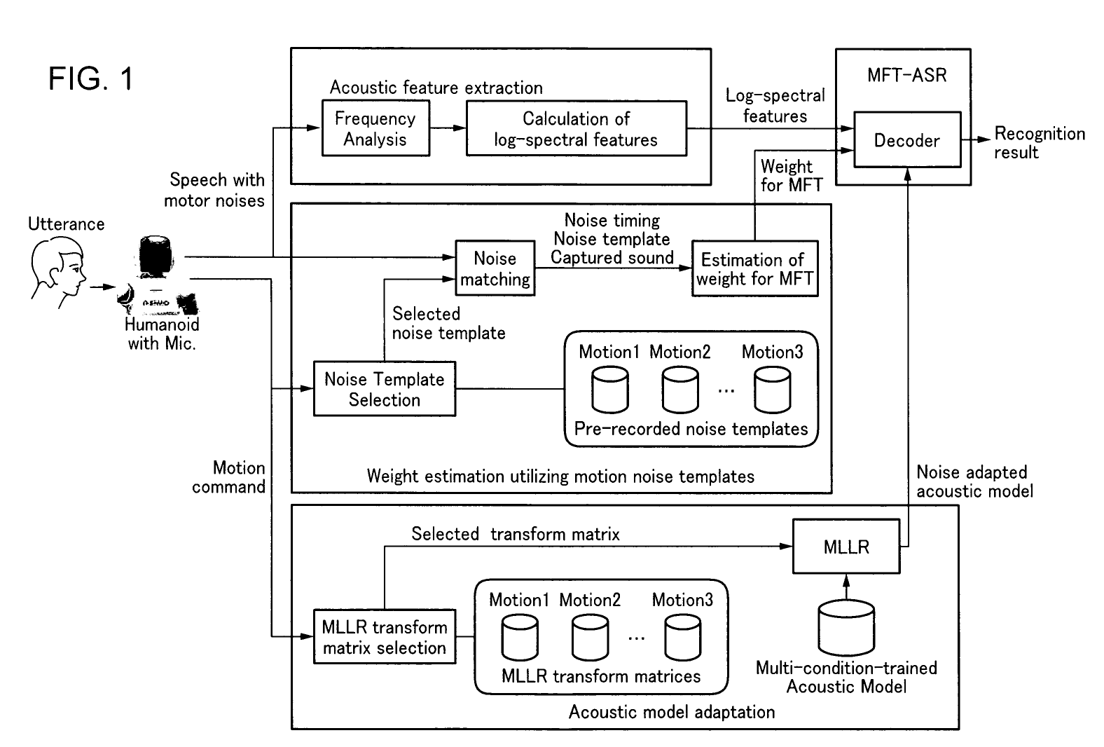

Hereinbelow, described are the details of the speech recognition method using multi-condition acoustic model training, MLLR, and MFT to cope with noise generated by a robot's motion. FIG. 1 illustrates the block diagram of the speech recognition method for a robot according to the present invention.

As acoustic features, we use log-spectral features, not mel-frequency cepstrum coefficient (MFCC). This is because log-spectral features are suitable for MFT as will be described below. The acoustic model is trained on the speech to which noises of all kinds of motions and gestures are added.

For each type of motion, an MLLR transformation matrix for the multi-condition acoustic model is learned using some amount of speech data. When recognizing speech contaminated by a motor noise, the MLLR transformation matrix for the corresponding motion type is applied.

In addition, the pre-recorded noise for the motion is selected from pre-recorded noise templates. The pre-recorded noise is matched to the target sound which is a mixture of speech and motor noise, and which frequency band of which time frame is damaged by the motor noise for determining weights for MFT. The details of this process are described later.

As described above, these three techniques have advantages and disadvantages. Multi-condition training would be effective for all noises; however, it might not be sufficient to adapt to each noise. MLLR enables adaption to each kind of noise; however, since MLLR's transform stays the same for all intervals of each speech, it might not work well for noises that change irregularly. MFT is expected to work well for such irregular noises; however, if the difference between pre-recorded noise and the noise included in the target speech is big, MFT is not effective.

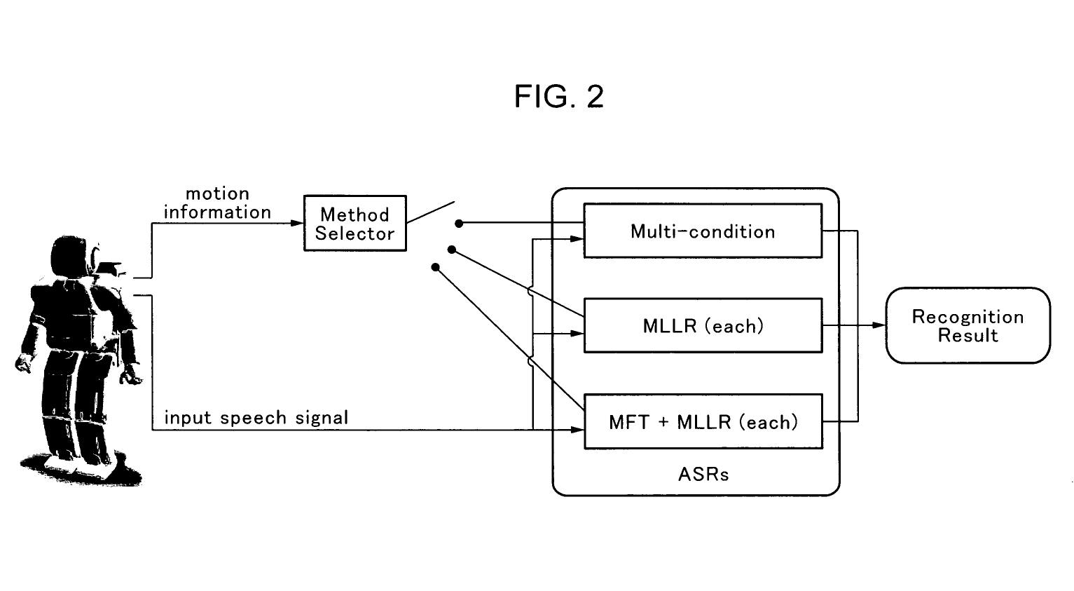

We therefore suspect that each of these is suitable for some types of noises and not suitable for other noises. We apply these techniques selectively according to the types of noises (FIG. 2). When the robot is performing a motion or a gesture and one of the techniques has been found to be effective for the noise of that motion/gesture, that technique is applied. By this selective application, degradation of ASR performance due to applying techniques that are not suitable for the noise can be prevented.

(Missing Feature Theory for Motor Noise)

Here we describe in detail how we apply MFT by using pre-recorded noises.

As stated above, throughout our method, we use log-spectral features as acoustic features. The reason for this is as follows. Motor noises to be handled are additive noises. To use the MFT for additive noises directly, we use log-spectrum acoustic feature vectors. A log-spectral acoustic feature vector is normalized in the log-spectrum domain while MFCCs are normalized in the cepstrum domain. The performance of ASR with the log-spectral acoustic feature vector is equivalent to that with MFCC mentioned above. Therefore, we use the log-spectral acoustic feature vectors.

In MFT, reliable features of the acoustic feature vector have large weight values and unreliable features have small weights. The weights affect the acoustic likelihood. When not using MFT, the acoustic likelihood of a phoneme model qₖ and the acoustic feature vector sₜ is defined by

$$L ( {s}_{t} \vert {q}_{k} ) = {\sum }^{N} L ( {s}_{ti} \vert {q}_{k} ) . \qquad ( 1 )$$

In MFT, using a weight ωᵢ, the acoustic likelihood is defined by

$$L ( {s}_{t} \vert {q}_{k} ) = {\sum }_{i = 1}^{N} {ω}_{i} L ( {s}_{ti} \vert {q}_{k} ) . \qquad ( 2 )$$

Weights for MFT are determined based on the noise level. Here, the log-spectrum of the estimated noise is defined by n(f, t), where f is the feature index in the log-spectrum acoustic feature vector, and t is the time frame. Because the range of log-spectrum is wide, we use the sigmoid function to limit the range of log-spectrum from 0 to 1. The average noise power at each frame is subtracted from the acoustic feature vector in order not to bias the value of output from the sigmoid function.

F is the number of dimensions of acoustic feature vector.

$${n}^{′} ( f , t ) = n ( f , t ) - \frac{1}{F} {\sum }_{g = 1}^{F} n ( g , t ) \qquad ( 3 )$$

Next, n′(f, t) is inputted to the sigmoid function. The reliability is defined by

$$ω ( f , t ) = 1 + \frac{α}{1 + exp ( {n}^{′} ( f , t ) )} \qquad ( 4 )$$

where α is a parameter to represent the sharpness of the reliability function ω. When α is large, the difference between the acoustic feature vectors becomes large, and vice versa. The reliability function ω is normalized so that the sum of the weights at a frame can be equal to the number of dimensions. This normalization suppresses the change in optimized values of parameters such as insertion penalty. The normalized ω is used for MFT.

When we use a multi-condition acoustic model, the stationary noises are incorporated into the acoustic model. We therefore apply MFT only when the estimated noise is stronger than an experimentally-defined threshold H.

When the types of motions are the same, the corresponding motor noises have similar spectral profiles. We recorded the noises of all motions beforehand. These noises are used as noise templates. We used the following method to match the noise templates and the target noises. Note that the noises contained in the target sound (a mixture of speech and noises) are referred to as target noises in this application. The N sample average of the difference between the noise template and the target noise D(s) is defined by

$$D ( s ) = \frac{1}{N} {\sum }_{n = 1}^{N} \vert {T ( s )}_{n} - {R}_{n} \vert . \qquad ( 5 )$$

where T and R are a noise template, and a target noise, respectively. T(s) or T(−s) means the acoustic feature vector shifted forward or backward at s samples. R is obtained as an acoustic signal including no speech data. R is extracted manually in this paper.

The matched sₘ is defined by

$${s}_{m} = {argmin}_{s} D ( s ) . \qquad ( 6 )$$

The acoustic features of T(sₘ) are sent to MFT weight calculation as n(f, t) in Equation (3) with time shift information sₘ.
(Experimental Results)

We conducted an experiment to investigate the effectiveness of the proposed method. We used the Honda Humanoid Robot ASIMO®. ASIMO has two microphones mounted on its head. We made evaluations using the data recorded from the left microphone.

The data were recorded in an anechoic room. This is because we wanted to avoid the effect of room reverberation and other environmental noise sources so that we can verify the efficacy of our proposed method, that is, to cope with the additive motor noises.

The data contained the speech signal recorded under the conditions where the distance from the speech source to the microphone was constant and the ASIMO's motors were switched off. We used the ATR 216 phonetically-balanced word set and conducted isolated word recognition experiments. There were 25 speaker's data in an ATR 216 phonetically-balanced word set and I speaker's data consisting of 216 Japanese word utterances. The duration of 1 word utterance was about 1.5 to 2 seconds. The speech data contained speeches of 25 speakers (12 males and 13 females). The acoustic model was trained on the data of 22 speakers, (10 males and 12 females). The unsupervised MLLR was applied to adapt to noises. The test set included speeches of 3 speakers (2 males and 1 female). This set was different from the training set. The noise data contained 34 kinds of noises: motor noise when ASIMO is not moving, gesture noises, noises when ASIMO is walking, and others. The SNR of each condition and motion pattern is shown in TABLE 2. The multi-condition acoustic model was trained on speech data to which 34 kinds of noises are added. We also used these 34 kinds of noises for the recognition experiment. The noises of these motions were recorded several times, and the noises for evaluation, multi-condition acoustic model training and template for matching were mutually exclusive.

We compared the speech recognition performances under the six conditions shown in TABLE 1. Since acoustic models with multi-condition training had been found effective by our preliminary experiment, we used them for all conditions. MLLR (all) means supervised MLLR for the noises of all 34 types of motions, and MLLR (each) means supervised MLLR for the noise of each type of motion. In the case of condition C, the weights for MFT in this condition were determined by the average of the noise over time; that is, the weights were the same for all time frames. On the contrary, in the case of condition F, the weights were computed for each time frame using the estimated noise. We also tested SS for reference. In SS, noises were estimated by the same matching algorithm as used for MFT. Since the application of MFT without MLLR resulted in worse performance than other conditions, the result of those conditions are not shown.

TABLE 1

| Condition | A | B | C | D | E | F |
|---|---|---|---|---|---|---|
| Multi-condition | ✓ | ✓ | ✓ | ✓ | ✓ | ✓ |
| MLLR (all) | | ✓ | ✓ | | | |
| MLLR (each) | | | | ✓ | ✓ | ✓ |
| MFT | | | ✓ | | | ✓ |
| SS | | | | | ✓ | |

TABLE 2

| | | | Word Accuracy (%) | | | | | | Best |
|---|---|---|---|---|---|---|---|---|---|
| Motion Pattern | | SNR (dB) | A | B | C | D | E | F | method |
| Motor noise w/o motion | | 8.93 | 77.93 | 77.01 | 76.23 | 81.02 | 80.25 | 80.09 | D* |
| Gesture | Right hand (1) | 6.06 | 77.31 | 77.47 | 74.85 | 77.93 | 69.60 | 75.77 | D |
| | Right hand (2) | 5.13 | 74.54 | 72.53 | 73.61 | 73.46 | 72.22 | 75.31 | F |
| | Right hand (3) | 6.76 | 77.78 | 77.47 | 76.85 | 77.78 | 77.93 | 77.62 | A or D |
| | Right hand (4) | 6.99 | 77.93 | 76.85 | 75.93 | 78.40 | 75.62 | 77.62 | D |
| | Right hand (5) | 6.96 | 77.93 | 77.01 | 78.55 | 77.47 | 73.61 | 79.32 | F |
| | Left hand (1) | 6.58 | 75.31 | 74.38 | 73.92 | 75.00 | 68.67 | 75.31 | A or F |
| | Left hand (2) | 6.16 | 73.46 | 72.99 | 72.69 | 73.15 | 70.22 | 72.99 | A |
| | Left hand (3) | 6.90 | 76.85 | 76.39 | 77.62 | 77.93 | 77.16 | 79.32 | F* |
| | Left hand (4) | 6.39 | 77.31 | 76.08 | 75.00 | 76.85 | 76.08 | 78.86 | F |
| | Left hand (5) | 7.11 | 78.09 | 77.31 | 75.46 | 77.93 | 72.38 | 76.70 | A |
| | Both hands (1) | 4.31 | 70.83 | 70.52 | 70.06 | 72.07 | 66.51 | 72.99 | F |
| | Both hands (2) | 5.31 | 71.30 | 70.52 | 68.83 | 71.14 | 67.13 | 69.60 | A |
| | Both hands (3) | 5.09 | 71.60 | 69.75 | 69.91 | 71.30 | 68.67 | 71.91 | F |
| | Both hands (4) | 5.54 | 72.38 | 70.83 | 72.53 | 72.84 | 70.22 | 73.92 | F |
| | Both hands (5) | 6.39 | 75.00 | 74.54 | 73.15 | 75.46 | 71.14 | 75.31 | D |
| | Head (1) | 7.01 | 77.62 | 76.23 | 70.22 | 77.62 | 74.07 | 73.30 | A or D |
| | Head (2) | 7.39 | 74.07 | 73.15 | 69.60 | 75.15 | 74.85 | 72.99 | D |
| | Head (3) | 7.54 | 75.15 | 73.77 | 73.92 | 75.62 | 75.77 | 76.85 | F |
| | Head (4) | −0.13 | 66.82 | 65.43 | 64.51 | 68.36 | 65.74 | 67.13 | D |
| | Head (5) | −0.42 | 66.05 | 64.66 | 65.12 | 66.67 | 63.58 | 67.28 | F |
| | Head and hands (1) | 2.45 | 65.74 | 65.12 | 63.27 | 64.97 | 62.81 | 64.51 | A |
| | Head and hands (2) | 3.11 | 66.51 | 64.97 | 63.12 | 66.20 | 60.34 | 63.89 | A |
| | Head and hands (3) | 6.33 | 74.54 | 73.77 | 74.07 | 75.15 | 72.38 | 76.39 | F |
| | Head and hands (4) | 4.76 | 73.15 | 71.91 | 71.76 | 70.99 | 70.06 | 72.84 | A |
| | Bow | 7.12 | 73.30 | 73.77 | 69.75 | 75.15 | 69.44 | 70.52 | D* |
| Walking | Pattern (1) | −5.81 | 60.65 | 58.80 | 62.35 | 61.11 | 61.73 | 63.43 | F |
| | Pattern (2) | −7.06 | 59.88 | 59.26 | 55.86 | 59.41 | 52.93 | 57.87 | A |
| | Pattern (3) | −4.24 | 67.75 | 65.90 | 64.97 | 68.36 | 63.43 | 65.90 | D |
| | Pattern (4) | −4.23 | 70.37 | 68.98 | 67.13 | 68.83 | 64.51 | 69.14 | A |
| | Pattern (5) | −4.16 | 66.51 | 65.59 | 64.81 | 66.98 | 58.80 | 67.13 | F |
| | Pattern (6) | −4.85 | 66.82 | 64.66 | 63.43 | 66.51 | 58.33 | 64.51 | A |
| | Pattern (7) | −3.77 | 70.37 | 68.98 | 67.13 | 68.83 | 64.51 | 69.14 | A |
| | Pattern (8) | −4.11 | 65.90 | 64.81 | 64.81 | 66.67 | 60.49 | 65.59 | D |

*shows the best method is better than A with the significance level p < 0.05.

TABLE 2 shows the experimental results. Conditions A, D, and F give better performance. In addition to multi-condition training, MLLR (each) and MFT are found effective for certain kinds of noises. On the contrary, MLLR (all) and SS are found to be not effective.

Based on the experimental results, we can consider it possible to improve speech recognition performance by selecting condition A, D, or F according to the types of motion/gesture. This selective application of noise-robust techniques would perform better than employing a fixed strategy, that is, using one of the conditions A, D, and F for all types of noises.

Although applying MLLR to each noise type and applying MFT may seem effective for certain kinds of noises, the improvement is rather small. We suspect that this is because the acoustic model based on multi-condition training is already well adapted to most of the noise types. The noises which were used in multi-condition training and the noises added to the target speech were recorded in exactly the same environment; however, these conditions are not practical. During robot speech recognition in a real environment, there is reverberation, and the distance between the human speaker and the robot changes. It is believed that if the environment is different, acoustic models obtained by multi-condition training is less effective and MLLR and MFT would achieve a more statistically significant improvement in ASR performance.

In this application, we have proposed an automatic speech recognition method that copes with a robot's own motor noises. In order to improve ASR under robots' own motor noises, our method used three techniques, that is, multi-condition training, MLLR adaptation, and the missing feature theory. In applying the missing feature theory, automatic estimation of unreliable acoustic features is a main issue. Our method solved this problem by utilizing information on a motion pattern obtained from a robot controller and a pre-recorded motor noise corresponding to the motion pattern. Also, it has another new feature that it selectively applies those three noise-robust techniques to according to the types of noises. The results of a preliminary experiments suggested that this method is effective.

For further improvement in ASR for a robot with motor noises, we still need to solve several problems. We should confirm the effectiveness of our method in a real environment with reverberation and in a dynamically-changing environment as mentioned above. In addition, it is required to improve noise estimation for the better weighting in MFT. We are also considering combining our method with sound source separation by using multi-channel microphones embedded in the robot.

### Second Embodiment

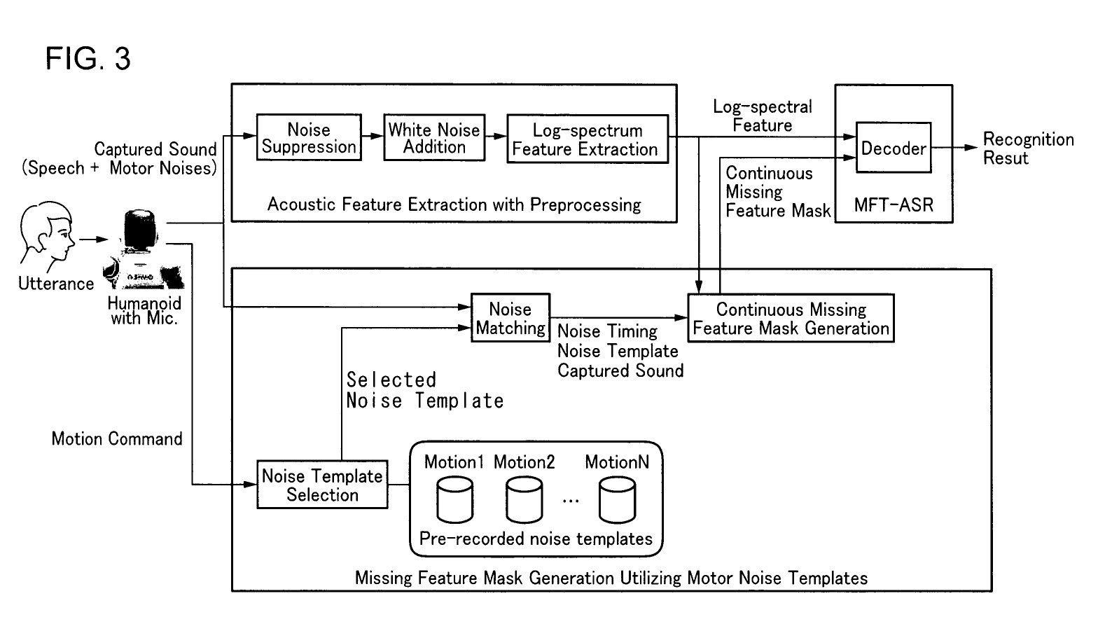

FIG. 3 shows the block diagram of the proposed method. It consists of three blocks—acoustic feature extraction with preprocessing, missing feature mask generation utilizing motor noise templates, and missing-feature-theory-based automatic speech recognition (MFT-ASR).

A. Acoustic Feature Extraction with Preprocessing

This block extracts acoustic features from noisy input suitable for MFT-ASR. It has three processes; noise suppression, white noise addition, and log-spectrum feature extraction.

1) Noise Suppression: The input speech has quite a low SNR of less than 0 dB. It is difficult to extract acoustic features robustly under such a noisy condition. So, first, noise suppression is performed as preprocessing of ASR. The noise suppression method we adopted is based on the known method described above.

2) White Noise Addition: There is no method to suppress noise without distortion. Such a distortion severely affects acoustic feature extraction for ASR, especially the normalization processes of an acoustic feature vector, because the distortion causes fragmentation of the target speech in the spectro-temporal space, and produce many sound fragments.

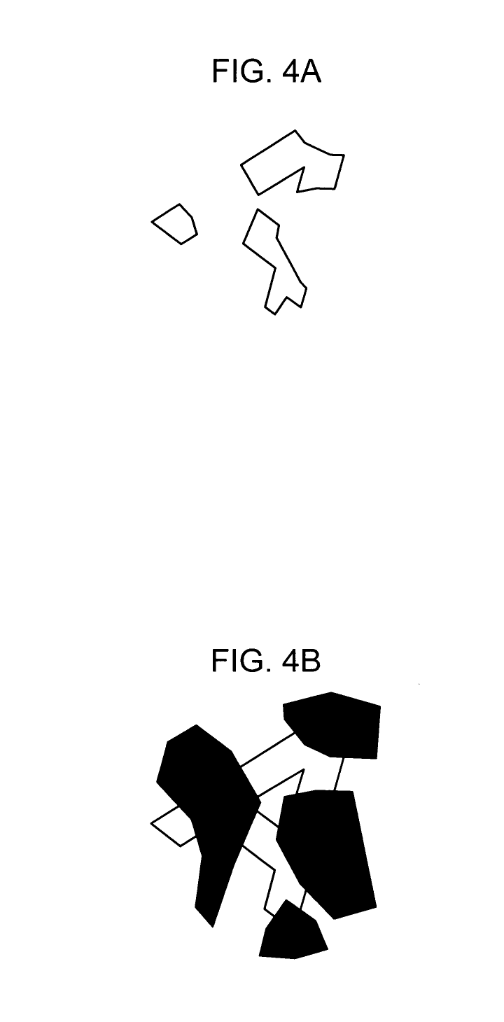

We can learn to solve this problem from human perception mechanisms. We use the psychological evidence that noise helps perception. FIGS. 4A and 4B depict an example of “perceptual closure” in Gestalt psychology. FIG. 4A shows that, in human perception, it is sometimes difficult to perceive organization from only fragments. FIG. 4B shows that other information such as occlusion and noise helps the organization of fragments. It is known that in the human auditory system noises that pad temporal gaps between sound fragments help auditory perception organization. This is a kind of perceptual closure, and is called “auditory induction”.

This evidence is also useful for ASR. We propose to add white noise to noise-suppressed speech signals. Because this process degrades speech quality in regard to SNR, one might expect that the performance of ASR would not be improved. However, it does improve the ASR performance for the following two reasons.
An additive white noise softens the distortions. Because it is a broad-band noise, it is effective for distortion in any frequency band. Actually, we add a white noise as strong as half of the noise-suppressed signal so that the power of distortion can be ignored. Therefore, the distorted speech signal plus the white noise is regarded as non-distorted speech plus white noise.
An acoustic model that is trained with white-noise-added speech data improves the performance of ASR for the white-noise-added speech. In this case, the system is able to assume only one type of noise included in speech, that is, white noise. It is easier for ASR to deal with one type of noise than various kinds of noises, and white noise is suitable for ASR using a statistic model.

The addition of low-level noises has been known as an approach to noise-robust ASR in the speech community. A low-level noise was added to blur distortion after spectral subtraction, and showed the feasibility of this approach in noisy speech recognition. The added noise was office background noise, that is, broadband with some colors in frequency domain. So, we use this technique more aggressively to attain higher noise-robustness. The added noise power is nearly half the speech power and we use white noise instead of colored noise. As far as we know this is the first application of this technique to a humanoid audition system. Therefore, we believe that our approach is original in this sense.

3) Log-spectrum Feature Extraction: After white noise is added, acoustic features are extracted. For acoustic features, we use log-spectral features, not MFCC. This is because of the characteristic of motor noises. Motor noise does not have uniform power over the frequency domain. Usually the power is concentrated in certain frequency bands. This means that the effect of the motor noise depends on the frequency subband. Once it is transformed to MFCC, the motor noise spreads over all coefficients, that is, all subbands in the Cepstrum domain. The feature reliability is estimated per subband, so feature vectors in a frequency domain are suitable for MFT-ASR. In the case of MFCC, three normalization processes are performed to obtain noise-robust acoustic features; CO normalization, liftering, and Cepstrum mean normalization. It is known that these processes are quite effective, so we conducted spectral normalization processes for log-spectral features—mean power normalization, spectrum peak emphasis and spectrum mean normalization—corresponding to the three normalization processes in MFCC. The details of spectrum normalization are described in.

B. Missing Feature Mask Generation Utilizing Motor Noise Templates

This block estimates a missing feature mask for MFT-ASR that represents which frequency band of which time frame is damaged by the motor noise. Automatic missing feature mask generation has been studied. This estimate is still difficult without using a priori information on speech and noise. In our case, however, the system estimates motor noises by using a motion command. So, this block estimates the missing feature mask by using a motor command and prerecorded motor noise templates. It includes three processes; noise template selection with pre-recorded motor noise templates, noise matching, and continuous missing feature mask generation.

1) Noise Template Selection: This process selects a prerecorded noise template corresponding to an input motion command. The noise template is selected from a pre-recorded noise template database. The database is constructed by recording the noises of all motions beforehand. In our system, 32 noise templates are currently stored in the database. The selected template is sent to noise matching process.

2) Noise Matching: The inputs to this process are the selected noise template and the captured sound obtained with the humanoid's microphone. When the types of motions are the same, the corresponding motor noises have similar spectral features. So, by matching the two inputs, the target noises included in the captured sound can be estimated. Note that, in this application, we call the noises contained in the target sound (a mixture of speech and noises) the target noises. We used the following method to match the noise templates and the target noises. The N sample average of the difference between the noise template and the target noise D(s) is defined by

$$D ( s ) = \frac{1}{N} {\sum }_{n = 1}^{N} \vert {T ( s )}_{n} - {R}_{n} \vert . \qquad ( 7 )$$

where T and R are a noise template, and a target noise, respectively. T(s) or T(−s) means the acoustic feature vector shifted forward or backward at s samples. R is obtained as an acoustic signal including no speech data.

The matched sₘ is defined by

$${s}_{m} = {argmin}_{s} D ( s ) . \qquad ( 8 )$$

The acoustic features of T(sₘ) is sent to the missing feature mask generation process with time shift information sₘ.

3) Continuous Missing Feature Mask Generation: This process uses time shift information of the target noise, the selected noise template, and the captured sound, to estimate a missing feature mask for each time frame. Each value in the missing feature mask is a reliability of the corresponding subband. We can say that we use a continuous missing feature mask, because the range of the reliability is from 0 to 1.

The missing feature mask is determined based on the noise level. We define several signals here. The log-spectrum of the estimated noise T(sₘ) is n(k, t), where k is the feature index in the log-spectrum acoustic feature vector, and t is time frame. The log-spectra of the input speech and the white-noise added signal after noise suppression are y(k, t) and p(k, t), respectively. The log-spectrum of the clean speech is estimated by
c′(k, t)=y(k, t)−n(k, t). (9)

The weight factor f(k, t) is calculated by

$$f ( k , t ) = \frac{\vert {C}^{′} ( k , t ) - {median}_{k} ( {C}^{′} ( k , t ) ) \vert}{P ( k , t ) - {C}^{′} ( k , t )} \qquad ( 10 )$$

where median k(a(k)) is a function that obtains the median value of a(k). P(k, t) and C′(k, t) are normalized spectra of p(k, t) and c_(k, t), respectively.

Because the range of the weight factor f(k, t) can be wide, we set an upper limit threshold fₜₕ so that f(k, t) can have a value from 0 to fₜₕ. fₜₕ is empirically set to 5.0. We, then, normalize it as missing feature mask w(k, t), so that the sum of the w(k, t) at a time frame can be equal to the number of dimensions of the acoustic feature vector K. This normalization suppresses the change in optimized values of parameters such as insertion penalty.

$$w ( k , t ) = \frac{k ( f , t )}{{\sum }_{k = 1}^{K} {f}^{′} ( k , t )} \\ {f}^{′} ( k , t ) = \{ \begin{matrix}f ( k , t ) & if & f ( k , t ) < {f}_{th} , \\ {f}_{th} & if & otherwise .\end{matrix} \qquad ( 11 )$$

C. Missing-Feature-Theory-Based Automatic Speech Recognition

In this block, the decoder recognizes input speech based on MFT. MFT is expected to work well for irregular noises. Most distortions and noises, besides white noise, are suppressed in the first block, but the acoustic feature still includes some kind of distortion. MFT is effective in dealing with such distortions. Note that if the difference between pre-recorded noise and the noise included in the target speech is large, MFT is less effective.

In MFT, reliable features of the acoustic feature vector have large weight values and unreliable features have small weights. The weights affect the acoustic likelihood. When not using MFT, the acoustic likelihood of a phoneme model qk and the acoustic feature vector sₜ is defined by

$$L ( {s}_{t} \vert {q}_{k} ) = {\sum }^{N} L ( {s}_{ti} \vert {q}_{k} ) . \qquad ( 12 )$$

In MFT, using a weight ωi, the acoustic likelihood is defined by

$$L ( {s}_{t} \vert {q}_{k} ) = {\sum }_{i = 1}^{N} {ω}_{i} L ( {s}_{ti} \vert {q}_{k} ) . \qquad ( 13 )$$

We evaluated the system throughout isolated word recognition to determine the effectiveness of the proposed method. We used Honda ASIMO as a testbed. ASIMO had two microphones mounted on its head. We used the data recorded through the left microphone.

We prepared two types of speech data sets for training and test data. As clean speech data, we used the ATR 216 phonetically-balanced word set. Nineteen speakers (9 males and 10 females) included in the word set were used for acoustic model training (hereafter dataset A₁). Furthermore, 3 speakers (2 males and 1 female) were used for isolated word recognition tests (hereafter dataset R₁). ASIMO has two microphones on its head, we selected ASIMO's left microphone for data capturing.

To make the training data set, we first played all speech data included in dataset A₁ through a loudspeaker, and recorded it with the left microphones in an anechoic room. The distance between ASIMO and the sound source was fixed at 100 cm, and the direction of the sound source was also fixed toward the center of ASIMO. ASIMO's stationary noise was also recorded with ASIMO on in the anechoic room. A training data set A₂ was then generated by adding the recorded speech data and noise.

The test data set was generated by performing a convolution of clean speech data and transfer functions from a sound source to ASIMO's left microphone. Motor noises were added to the convoluted speech data. The transfer functions were obtained by measurement of impulse responses. The impulse responses were measured in a 7 m (W)×4 m (D)×3 m (H) room. In this room, three walls of the room were covered with sound absorbing materials, and another wall was made of glass. The floor and the ceiling are flat and make echoes. There is a kitchen sink inside the room. We can hear sounds from an air-conditioner at a low frequency. So, the room has asymmetrical reverberation and a noise source in addition to the humanoid's motors. ASIMO was placed at the center of the room. The distance between ASIMO and the sound source was set at 50 cm, 100 cm, 150 cm, and 200 cm, and the direction of the sound source was fixed in direction to the front of ASIMO. The impulse response was measured at each point with ASIMO off. We also recorded 32 kinds of noises: stationary motor noise, gesture noises, and walking noises. These noise data were used not only for data set generation but also for making a pre-recorded noise template database. So, the noises of these motions were recorded several times so that the noises for test, multi-condition acoustic model training and the templates for matching would be mutually exclusive. A test data set R₂ was generated by adding the captured motor noises after convolution of R₁ and the measured transfer functions. We, thus, prepared two speech data sets: A₂ for training and R₂ for tests.

We, then, trained four triphone based acoustic models “AM-1” through “AM-4” by using the following data sets:
AM-1 the data set A₁ only (clean acoustic model),
AM-2 the data sets A₁ and A₂ (multi-condition trained acoustic model),
AM-3 the data set A₁ and a data set A₃ which was obtained by performing noise-suppression for A₂.
AM-4 the data set A₁ and a data set A₄ which was obtained by adding white noises to A₃.

Strictly, we might have to say that “AM-3” and “AM-4” are multi-condition trained models, because A₃ and A₄ still include motor noises. However, motor noises in A₃ are suppressed, so its noise level is greatly lower than A₂. A₄ is regarded as speech data with only white noise, that is, “uni-condition”. So, we defined “AM-3” and “AM-4” as non multi-condition trained acoustic models.

We compared the speech recognition performances for the six conditions shown in TABLE 3. Condition A is just conventional speech recognition with a clean acoustic model. In condition B, the system used a multi-condition trained acoustic model which is a common noise-robust technique. Most applications to robots and car navigation currently use this technique. So, we regard condition B as the baseline condition. In condition C, noise-suppressed speech signals were recognized without adding white noises by using conventional ASR. This will show the basic performance of noise suppression. In this case, we did not use mean power normalization in extracting log-spectrum acoustic features described above, because this normalization adversely affects log-spectrum acoustic features badly due to distortions in noise suppression. Actually, we confirmed that log-spectrum acoustic features without mean power normalization outperform those with this normalization. In condition D, noise-suppression and white noise addition are effective, but conventional ASR was used. So, this will show the effectiveness of white noise addition. Condition E is the proposed method. In this condition, noise suppression, white noise addition and MFT-ASR were performed. We expect that the performance in condition E to be the best among conditions A through E. Condition F is similar to the condition E. However, in missing feature mask generation, we gave the correct missing feature mask information to the system. The correct missing feature mask was generated by giving a motor noise included in the input speech as a noise template to the system. Condition F will exhibit the upper-limit in performance for our approach.

TABLE 3

| Condition | A | B | C | D | E | F |
|---|---|---|---|---|---|---|
| Multi-condition | | ✓ | | | | |
| Noise | | | ✓ | ✓ | ✓ | ✓ |
| Suppression | | | | | | |
| White Noise | | | | ✓ | ✓ | ✓ |
| Addition | | | | | | |
| MFT | | | | | ✓ | |
| MFT | | | | | | ✓ |
| (a priori mask) | | | | | | |
| Acoustic | AM-1 | AM-2 | AM-3 | AM-4 | AM-4 | AM-4 |
| Model | | | | | | |

TABLE 4 shows the experimental results. A large bold face number denotes the best result per noise type per distance among the conditions A through E, and large italic denotes the second best result. In the columns of condition E, P-values, which denote error rates of the proposed method (condition E) for the baseline (condition B), are shown. P-values of less than 10%, which are expected to statistically improve the performance with the proposed method, were emphasized in TABLE 4. P-values over 100% were shown as “-”.

Generally, condition F has the best performance because it uses a priori information to estimate missing feature masks. So, when the system does not use a priori information, condition E is the best. Condition B or D is second best. In the cases of gestures using a hand and walking motions at 200 cm, the proposed method showed a statistically-significant improvement in ASR performance according to P-values. We could not find a significant difference in the other cases, for head gestures and walking motions at the distances of 50 cm, 100 cm, and 150 cm.

TABLE 4

| Condition | A | B | C | D | E (P-value) | F | A | B | C | D | E (P-value) | F |
|---|---|---|---|---|---|---|---|---|---|---|---|---|
| | 50 cm | | | | | | 100 cm | | | | | |
| Motor Noise | 71.45 | 81.02 | 46.45 | 83.33 | 84.88 (0.03) | 83.18 | 66.20 | 82.25 | 50.00 | 82.87 | 83.49 (0.50) | 83.33 |
| Right hand (1) | 59.26 | 74.38 | 24.38 | 77.62 | 81.94 (0.00) | 82.10 | 44.60 | 68.52 | 20.68 | 71.45 | 77.62 (0.00) | 79.32 |
| Right hand (2) | 53.09 | 71.60 | 16.20 | 72.07 | 78.24 (0.00) | 78.86 | 39.66 | 63.27 | 13.73 | 60.34 | 68.52 (0.01) | 73.77 |
| Right hand (3) | 65.59 | 80.40 | 30.71 | 80.56 | 80.56 (1.00) | 81.94 | 54.78 | 78.09 | 28.86 | 75.77 | 79.01 (0.66) | 78.40 |
| Right hand (4) | 61.88 | 79.01 | 33.33 | 80.56 | 82.10 (0.10) | 85.03 | 50.62 | 72.99 | 29.78 | 76.23 | 81.33 (0.00) | 81.79 |
| Right hand (5) | 62.96 | 76.54 | 24.38 | 81.79 | 81.64 (0.01) | 82.25 | 48.30 | 72.69 | 19.91 | 75.62 | 80.40 (0.00) | 79.17 |
| Left hand (1) | 68.98 | 79.78 | 37.96 | 81.33 | 83.33 (0.05) | 83.95 | 59.10 | 80.40 | 36.27 | 80.40 | 82.56 (0.25) | 81.94 |
| Left hand (2) | 70.52 | 81.48 | 45.37 | 82.25 | 83.02 (0.39) | 84.41 | 62.04 | 81.33 | 43.83 | 78.24 | 82.41 (0.60) | 82.72 |
| Left hand (3) | 67.75 | 79.94 | 37.65 | 81.79 | 83.02 (0.08) | 83.18 | 54.17 | 77.31 | 34.72 | 75.31 | 80.86 (0.07) | 79.94 |
| Both hands (1) | 56.02 | 74.54 | 24.85 | 76.23 | 81.48 (0.00) | 80.09 | 40.28 | 66.36 | 21.30 | 66.67 | 73.77 (0.00) | 75.00 |
| Both hands (2) | 60.03 | 75.77 | 26.39 | 78.55 | 82.72 (0.00) | 83.64 | 47.07 | 69.14 | 25.46 | 70.37 | 75.77 (0.00) | 76.23 |
| Both hands (3) | 53.55 | 72.99 | 26.39 | 77.47 | 80.25 (0.00) | 79.94 | 45.22 | 66.98 | 20.83 | 68.83 | 73.15 (0.00) | 73.46 |
| Both hands (4) | 59.57 | 74.85 | 27.78 | 77.47 | 79.94 (0.01) | 81.17 | 47.07 | 70.37 | 24.69 | 70.99 | 77.16 (0.00) | 79.48 |
| Both hands (5) | 59.10 | 74.54 | 22.38 | 78.70 | 80.25 (0.00) | 81.33 | 46.60 | 69.14 | 18.21 | 71.45 | 77.47 (0.00) | 79.32 |
| Head (1) | 66.82 | 75.62 | 26.39 | 76.70 | 78.70 (0.11) | 83.49 | 56.64 | 74.54 | 22.84 | 66.05 | 73.46 (—) | 79.94 |
| Head (2) | 66.82 | 77.47 | 33.80 | 78.70 | 79.94 (0.22) | 83.95 | 58.02 | 77.01 | 34.72 | 74.69 | 74.69 (—) | 81.02 |
| Head (3) | 70.06 | 80.86 | 35.80 | 80.86 | 83.18 (0.21) | 82.25 | 64.51 | 81.94 | 35.65 | 79.32 | 78.40 (—) | 82.56 |
| Head (4) | 63.12 | 77.01 | 30.56 | 75.00 | 79.32 (0.26) | 79.48 | 48.77 | 71.45 | 29.78 | 64.35 | 75.93 (0.03) | 76.23 |
| Head (5) | 65.12 | 78.09 | 28.55 | 76.08 | 79.17 (0.63) | 81.48 | 56.64 | 75.00 | 28.86 | 70.22 | 75.15 (1.00) | 75.31 |
| Head and Hands (1) | 67.59 | 79.17 | 33.80 | 78.70 | 80.09 (0.67) | 82.72 | 58.33 | 78.55 | 32.72 | 74.07 | 75.15 (—) | 80.56 |
| Head and Hands (2) | 60.34 | 74.54 | 22.69 | 77.47 | 81.64 (0.00) | 81.17 | 44.60 | 66.20 | 21.14 | 71.76 | 75.62 (0.00) | 76.23 |
| Head and Hands (3) | 57.25 | 74.54 | 16.67 | 77.62 | 80.56 (0.00) | 81.02 | 43.67 | 67.90 | 14.51 | 66.51 | 70.83 (0.17) | 75.46 |
| Head and Hands (4) | 61.11 | 74.23 | 22.22 | 79.94 | 82.25 (0.00) | 82.41 | 47.69 | 68.36 | 22.53 | 73.46 | 78.55 (0.00) | 78.40 |
| Head and Hands (5) | 62.65 | 78.09 | 30.71 | 79.17 | 82.25 (0.03) | 83.49 | 50.77 | 72.22 | 27.31 | 72.38 | 76.85 (0.02) | 79.78 |
| Walking Motion (1) | 55.25 | 74.23 | 25.77 | 71.60 | 76.39 (0.30) | 79.17 | 44.75 | 70.06 | 23.61 | 60.03 | 66.98 (—) | 73.30 |
| Walking Motion (2) | 58.95 | 78.40 | 28.70 | 70.99 | 78.55 (1.00) | 78.86 | 47.22 | 72.53 | 25.46 | 59.57 | 69.29 (—) | 72.22 |
| Walking Motion (3) | 66.51 | 79.48 | 27.93 | 78.55 | 81.94 (0.20) | 81.48 | 53.09 | 77.31 | 27.47 | 67.90 | 75.93 (—) | 77.93 |
| Walking Motion (4) | 68.83 | 81.64 | 38.43 | 81.02 | 82.56 (0.65) | 82.41 | 56.79 | 79.48 | 36.73 | 74.54 | 80.71 (0.52) | 81.17 |
| Walking Motion (5) | 64.04 | 79.17 | 22.84 | 78.70 | 80.09 (0.67) | 80.71 | 47.22 | 76.23 | 20.52 | 66.98 | 72.99 (—) | 75.00 |
| Walking Motion (6) | 63.27 | 77.62 | 23.61 | 79.17 | 79.32 (0.41) | 82.07 | 50.00 | 76.39 | 20.83 | 68.06 | 75.93 (—) | 77.16 |
| Walking Motion (7) | 68.83 | 81.64 | 38.43 | 81.02 | 82.56 (0.65) | 82.41 | 56.79 | 79.48 | 36.73 | 74.54 | 80.71 (0.52) | 81.17 |
| Walking Motion (8) | 61.27 | 75.46 | 22.38 | 75.15 | 79.78 (0.02) | 81.02 | 45.37 | 72.69 | 19.60 | 64.35 | 70.22 (—) | 74.69 |
| | 150 cm | | | | | | 200 cm | | | | | |
| Motor Noise | 51.70 | 76.70 | 43.67 | 74.54 | 78.86 (0.26) | 78.09 | 41.51 | 69.14 | 40.28 | 68.21 | 72.22 (0.13) | 73.46 |
| Right hand (1) | 29.17 | 56.48 | 17.13 | 62.04 | 69.44 (0.00) | 68.21 | 22.99 | 44.91 | 14.04 | 52.47 | 60.34 (0.00) | 61.73 |
| Right hand (2) | 25.93 | 47.53 | 10.65 | 48.61 | 57.56 (0.00) | 65.43 | 18.98 | 38.12 | 7.25 | 39.51 | 50.46 (0.00) | 55.09 |
| Right hand (3) | 40.28 | 66.82 | 23.30 | 66.67 | 71.45 (0.03) | 72.84 | 33.02 | 57.25 | 20.06 | 58.95 | 65.74 (0.00) | 68.36 |
| Right hand (4) | 36.88 | 58.95 | 22.84 | 67.28 | 72.99 (0.00) | 75.46 | 27.62 | 49.69 | 16.51 | 55.09 | 65.90 (0.00) | 66.67 |
| Right hand (5) | 35.03 | 57.25 | 18.06 | 64.66 | 73.15 (0.00) | 73.46 | 26.39 | 46.14 | 13.43 | 55.86 | 63.89 (0.00) | 65.28 |
| Left hand (1) | 42.90 | 69.75 | 32.87 | 68.83 | 73.30 (0.07) | 74.23 | 32.25 | 60.19 | 28.24 | 59.41 | 67.44 (0.00) | 68.36 |
| Left hand (2) | 45.99 | 73.30 | 40.90 | 72.69 | 75.93 (0.20) | 76.85 | 36.73 | 63.12 | 35.34 | 63.58 | 72.22 (0.00) | 72.84 |
| Left hand (3) | 39.35 | 67.28 | 29.94 | 68.06 | 73.61 (0.00) | 73.92 | 31.33 | 55.40 | 25.93 | 58.49 | 65.28 (0.00) | 66.51 |
| Both hands (1) | 26.85 | 53.86 | 18.06 | 56.48 | 66.36 (0.00) | 67.75 | 19.75 | 43.83 | 14.81 | 45.99 | 55.40 (0.00) | 56.64 |
| Both hands (2) | 32.10 | 59.10 | 21.30 | 60.96 | 67.28 (0.00) | 68.52 | 25.15 | 49.38 | 15.74 | 51.54 | 59.10 (0.00) | 61.11 |
| Both hands (3) | 29.94 | 56.02 | 17.28 | 58.18 | 65.28 (0.00) | 66.67 | 21.30 | 47.53 | 14.35 | 48.77 | 56.64 (0.00) | 58.49 |
| Both hands (4) | 32.41 | 58.49 | 18.21 | 61.27 | 68.06 (0.00) | 71.30 | 25.00 | 50.00 | 16.20 | 51.85 | 60.49 (0.00) | 61.42 |
| Both hands (5) | 33.49 | 56.48 | 14.04 | 61.73 | 69.44 (0.00) | 71.60 | 24.07 | 46.76 | 11.42 | 51.85 | 58.02 (0.00) | 61.42 |
| Head (1) | 42.44 | 64.81 | 19.44 | 58.49 | 62.04 (—) | 72.84 | 34.72 | 58.64 | 16.20 | 48.15 | 57.72 (—) | 65.90 |
| Head (2) | 45.37 | 67.28 | 30.56 | 66.05 | 65.90 (—) | 75.31 | 37.65 | 61.73 | 25.62 | 55.71 | 57.72 (—) | 69.91 |
| Head (3) | 49.69 | 75.31 | 33.02 | 70.99 | 70.99 (—) | 76.08 | 40.43 | 64.81 | 29.63 | 62.19 | 66.67 (0.43) | 70.37 |
| Head (4) | 35.96 | 60.03 | 24.69 | 54.32 | 63.43 (0.15) | 66.05 | 26.08 | 50.00 | 21.14 | 46.91 | 57.41 (0.00) | 59.41 |
| Head (5) | 45.83 | 66.05 | 25.31 | 60.96 | 66.05 (—) | 67.13 | 36.42 | 58.18 | 22.07 | 50.46 | 58.02 (—) | 61.88 |
| Head and Hands (1) | 43.83 | 70.37 | 28.86 | 64.81 | 67.44 (—) | 76.23 | 34.88 | 59.57 | 26.85 | 58.18 | 61.88 (0.30) | 71.30 |
| Head and Hands (2) | 30.40 | 56.48 | 16.51 | 60.80 | 65.28 (0.00) | 68.83 | 22.84 | 46.14 | 14.66 | 50.15 | 58.18 (0.00) | 59.10 |
| Head and Hands (3) | 30.71 | 56.64 | 10.96 | 54.63 | 61.73 (0.02) | 66.67 | 22.84 | 46.76 | 9.41 | 46.14 | 52.93 (0.00) | 56.79 |
| Head and Hands (4) | 32.56 | 55.25 | 18.83 | 62.04 | 69.44 (0.00) | 71.60 | 24.69 | 45.83 | 14.04 | 56.94 | 63.12 (0.00) | 61.88 |
| Head and Hands (5) | 33.95 | 61.42 | 22.99 | 64.04 | 71.30 (0.00) | 71.76 | 26.54 | 53.55 | 18.21 | 56.33 | 61.57 (0.00) | 63.27 |
| Walking Motion (1) | 31.94 | 58.18 | 18.83 | 46.45 | 57.72 (—) | 62.19 | 23.61 | 46.60 | 15.74 | 39.66 | 51.23 (0.03) | 54.32 |
| Walking Motion (2) | 34.26 | 62.04 | 23.30 | 51.70 | 62.65 (0.82) | 64.20 | 24.07 | 51.54 | 20.06 | 42.44 | 53.09 (0.50) | 52.62 |
| Walking Motion (3) | 37.96 | 68.52 | 25.62 | 58.49 | 70.06 (0.50) | 69.44 | 29.17 | 58.18 | 21.91 | 49.38 | 57.87 (—) | 61.73 |
| Walking Motion (4) | 43.21 | 71.45 | 35.19 | 66.98 | 73.30 (0.39) | 74.07 | 35.19 | 61.57 | 29.78 | 59.72 | 67.75 (0.00) | 68.83 |
| Walking Motion (5) | 32.56 | 63.89 | 18.98 | 57.25 | 64.97 (0.65) | 69.44 | 26.08 | 51.08 | 15.43 | 45.22 | 55.86 (0.03) | 58.02 |
| Walking Motion (6) | 35.96 | 64.51 | 19.14 | 57.87 | 65.59 (0.65) | 68.52 | 27.62 | 55.40 | 15.90 | 47.99 | 56.02 (0.83) | 61.11 |
| Walking Motion (7) | 43.21 | 71.45 | 35.19 | 66.98 | 73.30 (0.39) | 74.07 | 35.19 | 61.57 | 29.78 | 59.72 | 67.75 (0.00) | 68.83 |
| Walking Motion (8) | 32.56 | 60.49 | 16.98 | 49.07 | 59.57 (—) | 64.81 | 23.77 | 49.69 | 14.04 | 41.05 | 49.38 (—) | 56.02 |

The reason why the proposed method did not work well for head gestures is that head motions are not especially noisy in ASIMO, that is, for these noises the input speech has a high SNR. Actually, we could not hear the sound of head motions. This causes ASR, in the cases of these head motions, to show good performance in condition A. In the cases of walking motions at 50 cm, 100 cm, and 150 cm, we can also say that the proposed method did not work properly again because of high SNR input. In these cases, noise sources are a little distance away from the microphone, because the microphone was installed on the head while noises came from the legs. So, the input SNR is higher than for other gestures. However, the effect of reverberation is stronger, so condition A did not deal with walking motions well regardless of high SNR input. When the distance to the target speech source was 200 cm, the proposed method was more effective because input SNR was low. Thus, we can say that the proposed method is more effective than multi-condition training in the case of low SNR input, and it is comparable in the case of high SNR input.

The only use of noise suppression (condition C) did not produce a good performance. This means that our noise suppression method handles strong distortions well enough to affect ASR. However, the combination of noise suppression and white noise addition (condition D) improve ASR performance equal to multi-condition training (condition B). If only white noise addition is applied, the noise level is much higher than target speech signals, and speech recognition would be more difficult for the system. So, this combination use is a key technique to cope with low SNR input.

The use of MFT (condition E) is basically effective, especially for low SNR inputs. The results show that the proposed method, that is, the combination of noise suppression, white noise addition and MFT is superior to multi-condition training. Compared with MFT with a priori missing feature mask (condition F), the proposed method is somewhat degraded by a very small amount. This means that our automatic missing feature mask generation succeeds in generating almost correct missing feature masks, and the use of pre-recorded noise templates is effective in coping with motor noises.

In this application, we have proposed an automatic speech recognition method that copes with a humanoid's own motor noises. In order to improve ASR when the humanoid's own motor noises are present, our method combined two techniques—noise suppression which is suitable for ASR, and missing feature-theory-based ASR utilizing pre-recorded motor noise templates. Usually, noise suppression is a technique to improve the SNR of the input speech. For ASR, high SNR speech is not always the optimal input, because distortion by noise suppression degrades the ASR performance. We solved this problem by adding white noise to noise-suppressed signals. This idea was inspired by psychological evidence of human audio perception. In applying the missing feature theory, automatic estimation of unreliable acoustic features is a main issue. Our method solved this problem by utilizing information on a motion pattern obtained from a humanoid controller and a pre-recorded motor noise corresponding to the motion pattern. We constructed the ASR system based on the proposed method using the Honda ASIMO. The experimental results using the constructed system demonstrated that this method is effective, especially for low SNR input.

### Third Embodiment

3. Noise Adaptation Method for Motion Noise Using the MFT

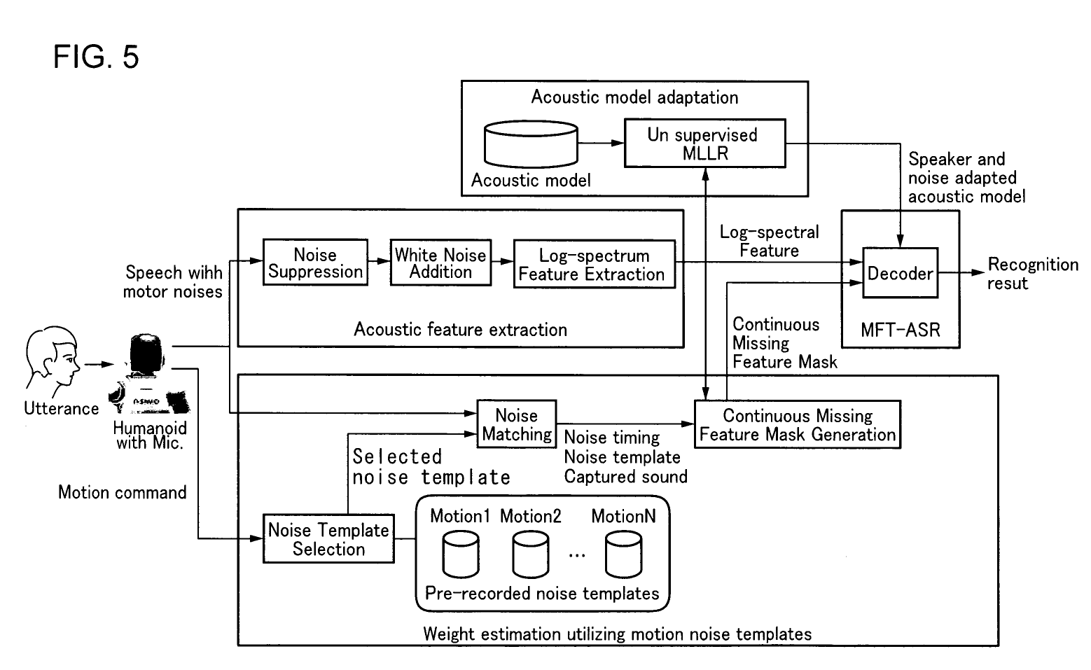

FIG. 5 is a block diagram of noise adaptation method in a third embodiment of the present invention.

3.1 Noise Suppression Process

Because the SNR of the input signal is small (may be as small as 0 dB or smaller), it is difficult, in such an environment, to extract acoustic features that are effective to ASR. Accordingly, a noise suppression process is applied to improve the SNR of the input signal. The SS method expressed by following Equation (14) is used for the noise suppression process.
|X(f)|=max{|X(f)|−\sqrt{α}| N̅|, \sqrt{β}| N̅|} (14)
where X(f) indicates the spectrum of the input signal, and N(top bar) indicates the average spectrum of noise signal that is overlaid on the input signal. The α and β are parameters used in the SS method, and generally used values (i.e., α=1, and β=0.1) are used in this embodiment.
3.2 Additive White Noise

The noise suppression process improves the SNR, however, at the same time, it produces distortion in the spectrum. The spectrum distortion adversely affects the ASR performance. Regardless of noise suppression methods, a large distortion may be produced depending on the background noise; therefore, a process for dealing with the spectrum distortion must be employed in ASR. Specifically, in the case of motion noise of a robot which is dealt with in this embodiment, it is predicted that the noise power is large, and the distortion is also large. Accordingly, in this embodiment, in order to reduce the spectrum distortion, a thin white noise is added after the noise suppression process is applied. It is expected, by adding stationary noise, that the component remaining after subtracting the noise can be flattened, and thereby the ASR performance can be improved.

Addition of white noise is represented by the following Equation (15) since it is believed that addition of white noise having certain percent of power of the input signal contributes to suppression of distortion,

$${y}^{′} ( t ) = y ( t ) + \frac{2 p}{T} {\sum }_{t = 1}^{T} \vert y ( t ) \vert \cdot random ( 1 ) \qquad ( 15 )$$

where y(t) is the signal remaining after applying the noise suppression process, random (1) is a function returning a real number in a range of −1 to +1. In this embodiment, p is assumed to be 0.1. In other words, white noise having 10% of power of the input signal in average is added.
3.3 Adaptation of Acoustic Model to the Noise Suppression Process

In robot speech recognition, it is believed that a method, in which an acoustic model obtained by a multi-condition training using speech data including stationary noise is used for training, is effective. Because a robot generates motor noise and fan noise even during a stable state, it is possible to improve the ASR performance, when compared with the case in which an acoustic model is trained by only using clean speech data, by carrying out training including the noises. It may be said that, the acoustic model obtained by a multi-condition training and used for a robot that always generates stationary noise is equivalent to a clean acoustic model that is used in general speech recognitions.

However, when the acoustic model obtained by a multi-condition training is used, the ASR performance may sometimes degrade after a noise suppression process is applied. This may be due to distortion in spectrum structure that is caused by the noise suppression process, or due to a large difference between the speech data during the training and the speech data during the recognition process, which is produced in such a manner that even the stationary noise generated by the robot is suppressed by the noise suppression process.

In this embodiment, in order to solve such a problem, the acoustic model is trained by using speech data remaining after noise is removed through the noise suppression process. As a result, the acoustic model is trained based on the speech data after the noise suppression process, and it is expected that degradation of the ASR performance due to the noise suppression process can be prevented.

3.4 Log-Spectrum Feature Extraction

After adding white noise, acoustic features are extracted. As the acoustic features, log-spectrum features are used instead of Mel Frequency Cepstrum Coefficients (MFCC) that are generally used in speech recognition. Noise such as motion noise is added in the spectrum region. However, because the MFCC generally used in speech recognition are the region obtained by applying Discrete Cosine Transform (DCT) to the spectrum, the noise added to a certain frequency band affects the entire acoustic features. In speech recognition using the MFT, it is necessary to extract frequency band with much noise and low reliability; therefore, the acoustic features in the spectrum region are preferable to the acoustic features in the cepstrum region. In the MFCC, after transforming to the cepstrum region, three normalization processes, i.e., removal of C₀ term, liftering, and CMS (Cepstrum Mean Subtraction), are applied. Because it is known that these three normalization processes are important to improve the ASR performance, these normalization processes are also applied in the spectrum region for the log-spectrum features that are used.

3.5 Production of MFT Mask

An MFT mask is produced for every frame and for every frequency band (i.e., for every dimension of the acoustic features). An automatic production of masks has been known. However, it is impossible in reality to produce a perfectly ideal mask. In this embodiment, because motion information of the robot itself can be obtained before actual motions, the motion noise is estimated based on such information. The estimation of the motion noise is carried out by temporal matching between the pre-recorded noise templates and the motion noise being presently input. Then, a mask is produced based on the input signal and the estimated motion noise. The detailed processes are explained below.

3.6 Selection of Noise Templates

The pre-recorded motion noises are input to a database as noise templates. In this embodiment, 34 kinds of motion noises are prepared. During the motion of the robot, noise templates are selected from the database in accordance with the kinds of the motions. It is assumed that the presently emitted motion noise coincides with the noise template, and then noise estimation is carried out by using the noise template.

3.7 Noise Matching

Even when the noise template is selected, the noise template does not coincide with the presently emitted noise in a time-wise manner. Therefore, temporal matching of the noises is necessary. The temporal matching is carried out in the following manner. The spectrum series of the noise templates is represented by T_{d}(f), and the spectrum series of the input signal is represented by I_{d}(f), where f indicates the frames, and d indicates the dimension of the spectrum along the frequency axis. If the window length (the number of samples) of one frame is represented by D, then 1≦d≦D. In addition, the maximum value of the spectrum of each of the dimensions of the noise templates is represented by M_{d}.

Here, if the input signal I_{d}(f) is greater than M_{d}, it is believed that the input signal includes speech signal, and thus such spectrum series is assumed to be 0.

$${I}_{d}^{′} ( f ) = \{ \begin{matrix}{I}_{d} ( f ) & if & {I}_{d} ( f ) \leq {M}_{d} \\ 0 & if & otherwise .\end{matrix} \qquad ( 16 )$$

The matching process is carried out by examining the mutual correlation between I′_{d} and T_{d}. A frame s_{d} having the maximum correlation is expressed by following Equation (17).

$${s}_{d} = {argmax}_{τ} {\sum }_{f = 0}^{N - 1} {I}_{d}^{′} ( f ) {T}_{d} ( f - τ ) \qquad ( 17 )$$

The maximum value of s_{d}, where 1≦d≦D, is represented by s_{match}, and s_{match} is used for the matching process.

The estimated noise after the matching process is obtained by following Equation (18).
E_{d}(f)=T_{d}(f−s_{match}) (18)
3.8 Production of Mask

First, the noise template T(s_{match}) obtained by the matching process is converted into log-spectrum. The noise of the log-spectrum obtained by conversion is represented by n(k,f), where k indicates the dimension (along the frequency axis), and f indicates the frame (along the time axis). Similarly, the log-spectrum including input noise is represented by y(k,f), and the log-spectrum to which white noise is added after the noise suppression process is represented by p(k,f). The estimated speech signal is expressed by following Equation (19).
c′(k, f)=y(k, f)−n(k, f). (19)

A mask m(k,f) is calculated by following Equation (20).

$$m ( k , f ) = \frac{\vert {C}^{′} ( k , f ) - {median}_{k} ( {C}^{′} ( k , f ) ) \vert}{P ( k , f ) - {C}^{′} ( k , f )} \qquad ( 20 )$$

where medianₖ(a(k)) is a function that obtains the median value of a(k). P(k,f) and C′(k,f) are normalized spectra of p(k,f) and c′(k,f), respectively. In order to prevent m(k,f) from becoming a too large value, a threshold tₜₕ is set, so that m(k,f) can have a value from 0 to tₜₕ. The value of tₜₕ is empirically set to 5.0.

Furthermore, the MFT mask is normalized. This normalization suppresses the change in optimized values of parameters such as insertion penalty. The normalized MFT mask is represented by w(k,f), and the normalization is carried out so that the sum of the w(k,f) at a time frame is equal to the number K of dimensions of the acoustic features.

$$w ( k , f ) = \frac{{m}^{′} ( k , f )}{{\sum }_{k = 1}^{K} {m}^{′} ( k , f )} \\ {m}^{′} ( k , f ) = \{ \begin{matrix}m ( k , f ) & if & m ( k , f ) < {t}_{th} , \\ {t}_{th} & if & otherwise .\end{matrix} \qquad ( 21 )$$

3.9 Calculation of the Acoustic Likelihood Based on MFT

MFT is also effective for irregular noises. The SNR can be improved by the noise suppression process and additive white noise, and furthermore, MFT is expected to work well for irregular noise components. However, if there is a large difference between the noise template and the actual noise, not so much effectiveness of MFT can be expected.

In MFT, the acoustic likelihood is calculated based on the definition that reliable portions of the acoustic features have large weight values and unreliable portions threreof have small weights. In conventional ASR in which MFT is not used, the acoustic likelihood of a phoneme model q₁ and the acoustic feature s_{f} is defined by following Equation (22).

$$L ( {s}_{f} \vert {q}_{l} ) = {\sum }_{i = 1}^{M} L ( {s}_{f} ( i ) \vert {q}_{l} ) . \qquad ( 22 )$$

When MFT is used, the acoustic likelihood is defined by following Equation (23), where the mask is represented by ω(k,f).

$$L ( {s}_{f} \vert {q}_{l} ) = {\sum }_{i = 1}^{M} ω ( i , f ) L ( {s}_{f} ( i ) \vert {q}_{l} ) . \qquad ( 23 )$$

4. Experiment Conditions

An evaluation experiment was conducted using a humanoid robot, Honda ASIMO®. The speech data were recorded through the left microphone of ASIMO, and an evaluation was conducted through an isolated word recognition. As the data for evaluation, the phonetically-balanced word set was used. The phonetically-balanced word set included speech data of 25 speakers (12 males and 13 females), and the number of speeches per a speaker was set to be 216. Each of speeches consists of one Japanese word such as “I-Ki-O-I”, and “I-Yo-I-Yo”.

Speech data of 19 speakers (9 males and 10 females) included in the word set were used for acoustic model training (hereafter training set A₁). The data was recorded in an anechoic room while the distance between the microphone and the sound source was fixed at 100 cm, and the training was carried out while SNR was varied (+5 dB, +10 dB, and +15 dB) so that changes in sound pressure could be flexibly absorbed. Speech data of 6 speakers (3 males and 3 females) included in the word set were used for the tests (hereafter test set R₁). The test data were spoken by speakers different from those for the acoustic model training. The data recording was conducted in a 7 m (W)×4 m (D)×3 m (H) room. In order to examine whether the ASR performance is sufficient in a real environment, the size of the room was determined to simulate a living room in home, and reverberation was allowed during the recording. The distance between the speaker and the microphone of the robot was set at 50 cm, 100 cm, 150 cm, and 200 cm. With regard to motion noise of the robot, 32 kinds of motions were used for recognition experiment. The motion noises included one stationary noise when ASIMO did not move after power was supplied, 25 gesture noises generated mainly during upper half body gestures such as “expressing good-by” or “bowing”, and 8 walking noises generated mainly during leg motion such as “straight forwarding” or “rotation”. A test set R₂ was generated by adding the motion noise to the test set R₁.

In order to compare the proposed method with a conventionally effective method in which an acoustic model obtained by multi-condition training was used, data set for the multi-condition training was also prepared. For the multi-condition training, in addition to the training set A₁, training set A₂ to which stationary noise such as motor noise or fan noise generated after power was supplied was added, and training set A_{3(N)} to which the motion noises (motion 1≦N≦34) were added, were prepared. For the ASR experiment, the following five acoustic models were prepared:
AM-1 in which only the training set A₁ was used (clean model);
AM-2 in which the training sets A₁ and A₂ were used (multi-condition trained model 1);
AM-3 in which the training sets A₁ and A_{3(N)} were used (multi-condition trained model 2);
AM-4 in which the training set A₄ was used, the training set A₄ being obtained by performing noise-suppression for A₁ and A₂; and
AM-5 in which the training set A₅₍ₚ₎ was used, the data set A₅₍ₚ₎ being obtained by adding white noises to A₁ and A₄.

Because the acoustic model AM-3 was generated for every noise environment, the acoustic model AM-3 actually included 34 kinds of models. Moreover, because the magnitude of the added white noise was varied in the case of the acoustic model AM-5, the acoustic model AM-5 actually included 4 kinds of models in which p was respectively set at 0.05, 0.1, 0.2, and 0.4 in Equation (15).

Before conducting the evaluation experiment, an ASR experiment using three acoustic models was conducted for establishing the baseline. The conditions for the baseline are shown in TABLE 5. Condition A is just conventional speech recognition with a clean acoustic model. In conditions B and C, a multi-condition trained acoustic model which is a noise-robust technique was used. In condition B, the acoustic model was trained by only using stationary noise, whereas in condition C, the acoustic model was trained by also using irregular noises, i.e., motion noises of the robot.

The experiment includes the following three stages.

4.1 Verification of Effectiveness of Noise Suppression Process

Here, improvement of the ASR performance by using a noise suppression process was verified. The compared methods are shown in TABLE 6. In condition D, ASR was carried out by applying a noise suppression process, and by using the multi-condition trained acoustic model (i.e., multi-condition trained model 1). In condition E, ASR was carried out by using an acoustic model that was trained by using speech data obtained after applying a noise suppression process. In each of conditions F to I, ASR was carried out by using an acoustic model that was trained by using speech data obtained by adding white noise after applying a noise suppression process. In these conditions, the value of p in Equation (15) was varied.

4.2 Verification of Effectiveness of Employment of MFT

Next, improvement of the ASR performance by using the proposed MFT was verified. The method under condition G in which an acoustic model was trained by using speech data obtained by adding white noise after applying a noise suppression process, and the methods under conditions J to L in which ASR by MFT were carried out under condition G were compared. For addition white noise, p was set to 0.1. The value 0.1 was selected as an intermediate value because the optimum value p depends on distance and motion.

In ASR using MFT, the mask was determined under the following three conditions. In condition J, a real environment was simulated, and, during the noise matching process, matching between the input signals including both noise and speech data and the noise templates was carried out. The noise templates were pre-recorded noise, and these were motion noises similar to the noises in the input signals; however, were not identical to them. The noise templates and the noises in the input signals were overlaid with temporal and random shifting of 0 ms to 200 ms from the matched moment. Condition K was more idealistic than condition J, and matching could be easily achieved therein. In this condition, it was assumed that noise period was perfectly extracted, and the matching between the noise templates and the noises in the input signal was carried out only in the noise period. In this condition, the noise templates and the noises in the input signals were the same types of motion noises; however, these were not identical. Condition L was the most idealistic condition, and did not simulate a real environment. In this condition, the mask was determined by assuming that the noises were perfectly known. For reference, an experiment was conducted to find how well the ASR performance could be when the noises were perfectly known. Accordingly, the estimated noises in conditions J and K were not identical to the noises in the input signals, whereas in condition L, the noises in the input signals were estimated.

4.3 Verification of Effectiveness of Employment of MLLR

An experiment was conducted with regard to the combination of the MLLR that is generally used as a noise-robust method and the proposed method. In this embodiment, communications with unspecified people were taken into account in human-robot communications, an unsupervised MLLR was carried out. More specifically, for example, it is assumed that a guide robot is placed in an exhibition hall, and an acoustic model is trained by MLLR using input speech between the robot and a person. As conversation progresses, the ASR performance is assumed to be improved.

The compared methods are shown in TABLE 8. Conditions B′, C′, and J′ to L′ are the cases obtained by applying unsupervised MLLRs to conditions B and C shown in TABLE 5 and conditions J to L shown in TABLE 7, respectively. Through this experiment, the combination of a conventionally effective method in which an acoustic model obtained by multi-condition training is used with MLLR and the combination of the proposed method with MLLR were compared.

TABLE 5
(Experimental Conditions 1 (Baseline))

| | Condition | | |
|---|---|---|---|
| | A | B | C |
| Multi-condition (Stationary) | | ✓ | |
| Multi-condition (Motion) | | | ✓ |
| Noise Suppression (SS) | | | |
| Adaptation for SS | | | |
| White Noise Addition | | | |
| Acoustic Model | AM-1 | AM-2 | AM-3 |

TABLE 6
(Experimental Conditions 2 (Noise Suppression))

| Condition | D | E | F | G | H | I |
|---|---|---|---|---|---|---|
| Multi-condition (Stationary) | ✓ | | | | | |
| Multi-condition (Motion) | | | | | | |
| Noise Suppression (SS) | ✓ | ✓ | ✓ | ✓ | ✓ | ✓ |
| Adaptation for SS | | ✓ | ✓ | ✓ | ✓ | ✓ |
| White Noise Addition | | | p = 0.05 | p = 0.1 | p = 0.2 | p = 0.4 |
| Acoustic Model | AM-2 | AM-4 | AM-5 | AM-5 | AM-5 | AM-5 |

TABLE 7
(Experimental Conditions 3 (MFT))

| | Condition | | |
|---|---|---|---|
| | J | K | L |
| Noise Suppression (SS) | ✓ | ✓ | ✓ |
| Adaptation for SS | ✓ | ✓ | ✓ |
| White Noise Addition | p = 0.1 | p = 0.1 | p = 0.1 |
| MFT (voice + noise matching) | ✓ | | |
| MFT (only noise matching) | | ✓ | |
| MFT (known noise) | | | ✓ |
| Acoustic Model | AM-5 | AM-5 | AM-5 |

TABLE 8
(Experimental Conditions 4 (MLLR))

| Condition | B′ | C′ | J′ | K′ | L′ |
|---|---|---|---|---|---|
| Multi-condition | ✓ | | | | |
| (Stationary) | | | | | |
| Multi-condition (Motion) | | ✓ | | | |
| Noise Suppression (SS) | | | ✓ | ✓ | ✓ |
| Adaptation for SS | | | ✓ | ✓ | ✓ |
| White Noise Addition | | | p = 0.1 | p = 0.1 | p = 0.1 |
| MFT | | | ✓ | | |
| (voice + noise matching) | | | | | |
| MFT | | | | ✓ | |
| (only noise matching) | | | | | |
| MFT (known noise) | | | | | ✓ |
| Un supervised MLLR | ✓ | ✓ | ✓ | ✓ | ✓ |
| Acoustic Model | AM-1 | AM-2 | AM-5 | AM-5 | AM-5 |

5. Experimental Results

The ASR results obtained as the baseline are shown in TABLE 9. The best results obtained in conditions A to C are typed in bold. Conditions B and C correspond to the ASR results obtained by using the multi-condition trained acoustic models. As shown, it is confirmed that the results obtained by using the multi-condition trained acoustic models are better than the results obtained by using the clean acoustic models. Which is better in condition B or condition C depends on environment; however, in overall, condition C gives preferable performance; therefore, in the following description, condition C is treated as a conventional method and compared with the proposed method.

5.1 Effectiveness of Noise Suppression Process

The experimental results are shown in TABLE 10. The conditions that exhibited the best ASR performance are typed in bold.

In condition D, the ASR results that were obtained by applying the Spectral Subtraction (SS) and by using the multi-condition trained acoustic model are shown. When comparing the results in condition B and in condition D, the ASR results in condition D were worse. The difference between condition B and condition D is that the Spectral Subtraction (SS) was not applied in condition B whereas the Spectral Subtraction (SS) was applied in condition D. The reason for degradation of the ASR performance with the Spectral Subtraction (SS) is believed to be the enlarged difference between the speech data at recognition and the speech data at training due to suppression of noise.

In condition E, the acoustic model was trained using the speech data to which the Spectral Subtraction (SS) had been applied. The results in condition E exhibited better ASR performance than the results in condition D. Moreover, most of the results in condition E exhibited better ASR performance than the results in condition B. It was confirmed that effectiveness of the noise suppression process could be obtained by training the acoustic model using the speech data to which the noise suppression process had been applied.

In conditions F to I, white noise was added in order to reduce distortion generated by the Spectral Subtraction (SS). The acoustic model was trained using the speech data to which the noise suppression process had been applied and white noise had been added, and similar processes were also applied to the input signals during the recognition. When comparing the results in condition E and in conditions F to I, most of the best ASR performance results were included in the results in conditions F to I. Based on these results, it was confirmed that the ASR performance could be improved by adding white noise. It was not possible to unambiguously determine the specific one among conditions F to I that exhibited the best ASR performance. The magnitude of white noise (p value in Equation (15)) that made the ASR performance best depended on noise environment; however, it was at least confirmed that addition of white improved the ASR performance.

5.2 Effectiveness of Combination with MFT

The experimental results of ASR using the MFT are shown in TABLE 11. The most practical condition is condition J, and the results obtained in condition J that exhibited better ASR performance than the results in condition C are typed in bold. The statistical significance of the results in condition J compared with the results in condition C were confirmed, where the level of significance was set to value p.

For addition of white noise, p value was set to be 0.1. Based on the experimental results, it was confirmed that the proposed method exhibited better ASR performance than the conventional method, in which a multi-condition trained acoustic model was used, in any noise environments and at any distances. Accordingly, the effectiveness of the proposed method was confirmed.

Moreover, when comparing the results in condition G in which the MFT was not applied and the results in condition J in which the MFT was applied, the results in condition J generally exhibited better ASR performance the results in condition G; therefore, it was confirmed that robustness against motion noise of a robot could be improved by applying the MFT.

5.3 Effectiveness of Combination with Unsupervised MLLR

TABLE 12 shows the experimental results of ASR using a method in which the multi-condition trained acoustic model was used and the experimental results of ASR using the proposed method combined with unsupervised MLLR. The best ASR results obtained in conventional methods B′ and C′ and the proposed method J′ are typed in bold. As in TABLE 11, the statistical significance of the results in condition J′ compared with the results in condition C′ were confirmed, and value p was determined. The proposed method exhibited better ASR performance than that in condition C′ in most of the noise environments with a few exceptions, specifically, the proposed method clearly exhibited better ASR performance at a distance of 200 cm. Based on the experimental results, it was confirmed that the proposed method even combined with MLLR, which has been known as an effective adaptation method for acoustic models, exhibited better ASR performance than the conventional method.

TABLE 9
Isolated Word Recognition 1 (% Word Correct)

| | 50 cm | | | 100 cm | | | 150 cm | | | 200 cm | | |
|---|---|---|---|---|---|---|---|---|---|---|---|---|
| Condition | A | B | C | A | B | C | A | B | C | A | B | C |
| Motor noise | 59.19 | 83.34 | 83.34 | 40.44 | 74.23 | 74.23 | 27.86 | 64.20 | 64.20 | 19.83 | 54.01 | 54.01 |
| Right hand (1) | 50.93 | 81.25 | 79.63 | 30.71 | 67.67 | 68.60 | 19.68 | 56.02 | 56.33 | 12.27 | 45.60 | 46.38 |
| Right hand (2) | 45.45 | 77.63 | 73.84 | 26.00 | 64.97 | 60.80 | 15.36 | 50.70 | 49.54 | 9.57 | 41.44 | 38.89 |
| Right hand (3) | 51.32 | 79.63 | 78.55 | 32.56 | 67.75 | 69.60 | 21.37 | 56.56 | 56.49 | 12.89 | 46.53 | 46.92 |
| Right hand (4) | 52.70 | 82.64 | 79.94 | 32.95 | 69.14 | 69.83 | 20.99 | 56.02 | 57.10 | 12.50 | 46.30 | 49.23 |
| Right hand (5) | 50.70 | 81.02 | 81.17 | 31.10 | 68.52 | 69.99 | 18.52 | 55.48 | 57.95 | 11.27 | 46.61 | 46.76 |
| Left hand (1) | 50.31 | 78.32 | 79.79 | 30.48 | 65.05 | 65.36 | 18.83 | 54.55 | 53.32 | 10.73 | 42.29 | 44.22 |
| Left hand (2) | 44.60 | 74.69 | 74.38 | 24.31 | 59.88 | 60.27 | 13.81 | 47.38 | 47.46 | 6.71 | 36.65 | 37.89 |
| Left hand (3) | 51.55 | 80.25 | 79.32 | 32.72 | 68.21 | 69.29 | 21.45 | 55.25 | 54.63 | 12.74 | 44.76 | 47.15 |
| Left hand (4) | 47.45 | 74.62 | 74.85 | 29.32 | 60.42 | 60.81 | 16.82 | 50.00 | 50.31 | 10.34 | 39.51 | 39.67 |
| Left hand (5) | 52.01 | 79.40 | 79.94 | 32.72 | 65.43 | 66.05 | 19.91 | 54.01 | 52.55 | 11.19 | 43.75 | 44.14 |
| Both hands (1) | 45.07 | 76.70 | 75.08 | 25.31 | 61.19 | 61.50 | 15.20 | 51.01 | 49.08 | 7.79 | 39.05 | 38.50 |
| Both hands (2) | 44.29 | 74.54 | 74.31 | 25.47 | 59.18 | 59.88 | 15.44 | 49.00 | 47.46 | 8.57 | 38.82 | 40.20 |
| Both hands (3) | 43.60 | 73.61 | 74.46 | 25.62 | 58.10 | 60.65 | 16.52 | 45.99 | 48.38 | 8.57 | 35.42 | 39.43 |
| Both hands (4) | 43.37 | 74.08 | 74.38 | 24.62 | 59.88 | 57.87 | 15.13 | 46.61 | 47.15 | 7.56 | 36.35 | 36.96 |
| Both hands (5) | 45.91 | 76.93 | 75.47 | 26.01 | 61.58 | 62.50 | 15.59 | 49.00 | 50.00 | 8.41 | 39.35 | 41.36 |
| Head (1) | 45.84 | 63.89 | 67.21 | 23.69 | 50.23 | 51.39 | 13.74 | 36.89 | 40.13 | 7.02 | 26.78 | 30.63 |
| Head (2) | 53.25 | 73.23 | 76.16 | 34.57 | 59.80 | 64.12 | 21.68 | 51.62 | 51.47 | 14.81 | 42.05 | 42.60 |
| Head (3) | 50.39 | 74.31 | 74.92 | 31.79 | 62.04 | 61.96 | 18.45 | 51.01 | 50.62 | 11.81 | 41.13 | 42.29 |
| Head (4) | 29.94 | 44.91 | 50.16 | 17.83 | 33.88 | 38.27 | 11.81 | 24.62 | 30.87 | 7.26 | 19.83 | 25.46 |
| Head (5) | 30.79 | 46.22 | 52.01 | 17.90 | 34.88 | 40.97 | 10.57 | 28.47 | 32.87 | 6.56 | 21.22 | 26.39 |
| Head and Hands (1) | 51.24 | 74.38 | 77.24 | 33.57 | 61.81 | 65.51 | 20.84 | 52.55 | 53.86 | 14.20 | 41.67 | 45.14 |
| Head and Hands (2) | 51.31 | 66.59 | 70.99 | 31.18 | 55.79 | 59.03 | 19.91 | 44.14 | 48.46 | 13.66 | 35.88 | 41.05 |
| Head and Hands (3) | 37.50 | 63.81 | 66.67 | 19.53 | 48.85 | 51.85 | 9.11 | 38.04 | 39.66 | 4.94 | 27.39 | 30.41 |
| Head and Hands (4) | 46.38 | 77.70 | 77.47 | 27.24 | 63.04 | 63.35 | 15.21 | 50.23 | 50.54 | 8.49 | 38.97 | 42.59 |
| Head and Hands (5) | 47.38 | 73.30 | 73.46 | 27.47 | 60.27 | 59.57 | 16.67 | 47.77 | 46.76 | 9.11 | 37.27 | 38.58 |
| Walking Motion (1) | 50.00 | 74.00 | 73.23 | 29.94 | 62.19 | 64.05 | 19.29 | 52.09 | 54.32 | 12.12 | 41.13 | 42.13 |
| Walking Motion (2) | 46.91 | 71.30 | 71.22 | 29.40 | 56.95 | 60.65 | 18.68 | 45.68 | 48.23 | 11.58 | 36.96 | 38.04 |
| Walking Motion (3) | 49.38 | 74.08 | 74.39 | 30.32 | 64.05 | 64.74 | 19.29 | 51.47 | 51.00 | 12.19 | 42.21 | 41.75 |
| Walking Motion (4) | 50.78 | 75.85 | 77.47 | 32.33 | 65.51 | 66.82 | 19.91 | 55.10 | 54.09 | 12.35 | 45.06 | 44.06 |
| Walking Motion (5) | 52.01 | 76.08 | 75.77 | 34.11 | 67.59 | 66.67 | 20.91 | 55.09 | 54.02 | 12.42 | 45.99 | 45.60 |
| Walking Motion (6) | 46.99 | 74.85 | 74.70 | 29.63 | 61.81 | 62.35 | 17.83 | 51.55 | 51.47 | 10.50 | 40.90 | 40.66 |
| Walking Motion (7) | 49.85 | 75.24 | 76.62 | 32.41 | 66.51 | 66.59 | 19.91 | 54.40 | 55.02 | 12.97 | 44.37 | 45.99 |
| Walking Motion (8) | 50.85 | 76.62 | 72.92 | 33.41 | 67.75 | 63.97 | 20.45 | 55.71 | 51.32 | 12.89 | 43.37 | 42.60 |

TABLE 10
Isolated Word Recognition 2 (% Word Correct)

| Condition | D | E | F | G | H | I | D | E | F | G | H | I |
|---|---|---|---|---|---|---|---|---|---|---|---|---|
| | 50 cm | | | | | | 100 cm | | | | | |
| Motor noise | 67.60 | 84.26 | 82.26 | 84.42 | 85.65 | 84.34 | 60.11 | 79.56 | 78.32 | 78.94 | 78.94 | 76.39 |
| Right hand (1) | 64.74 | 82.10 | 80.71 | 82.87 | 82.33 | 79.25 | 57.87 | 73.15 | 73.53 | 73.38 | 73.23 | 66.67 |
| Right hand (2) | 58.10 | 75.46 | 73.77 | 75.54 | 77.09 | 73.62 | 47.84 | 65.97 | 63.28 | 62.66 | 62.89 | 57.49 |
| Right hand (3) | 63.89 | 80.25 | 79.55 | 80.79 | 80.94 | 77.24 | 55.02 | 70.45 | 71.38 | 71.45 | 70.22 | 63.35 |
| Right hand (4) | 64.51 | 81.02 | 81.64 | 83.64 | 83.80 | 81.18 | 55.40 | 70.53 | 70.91 | 72.92 | 72.30 | 68.98 |
| Right hand (5) | 63.35 | 82.02 | 79.63 | 81.33 | 81.87 | 78.94 | 54.63 | 70.99 | 72.38 | 72.84 | 71.30 | 65.82 |
| Left hand (1) | 62.04 | 78.32 | 78.71 | 81.18 | 83.65 | 80.17 | 49.54 | 66.05 | 68.29 | 69.52 | 70.22 | 65.05 |
| Left hand (2) | 56.02 | 73.46 | 73.30 | 75.62 | 77.01 | 72.61 | 45.53 | 58.88 | 61.04 | 60.26 | 61.04 | 59.03 |
| Left hand (3) | 64.74 | 79.17 | 80.09 | 82.33 | 82.95 | 80.25 | 55.40 | 68.14 | 70.53 | 70.99 | 71.14 | 68.75 |
| Left hand (4) | 50.93 | 63.20 | 63.97 | 68.52 | 71.61 | 70.29 | 36.04 | 49.92 | 49.93 | 54.87 | 55.33 | 53.16 |
| Left hand (5) | 62.04 | 78.47 | 78.25 | 82.72 | 82.10 | 79.48 | 52.47 | 67.06 | 69.83 | 70.37 | 69.68 | 64.74 |
| Both hands (1) | 59.11 | 77.86 | 76.78 | 78.47 | 79.17 | 76.55 | 46.53 | 63.43 | 64.74 | 66.52 | 66.28 | 61.88 |
| Both hands (2) | 57.57 | 75.70 | 76.00 | 77.93 | 77.55 | 73.31 | 48.15 | 61.96 | 63.74 | 63.27 | 62.89 | 57.79 |
| Both hands (3) | 56.10 | 74.23 | 74.69 | 76.39 | 77.01 | 74.08 | 45.76 | 60.34 | 62.04 | 62.12 | 62.35 | 58.65 |
| Both hands (4) | 58.88 | 75.08 | 75.39 | 77.62 | 78.55 | 75.24 | 47.30 | 62.35 | 63.74 | 63.12 | 63.20 | 58.64 |
| Both hands (5) | 60.19 | 77.70 | 77.63 | 78.16 | 79.09 | 75.85 | 50.16 | 63.58 | 65.67 | 65.82 | 65.67 | 60.65 |
| Head (1) | 40.97 | 54.94 | 58.49 | 62.50 | 64.74 | 66.05 | 30.40 | 43.98 | 45.07 | 48.15 | 47.61 | 50.54 |
| Heed (2) | 52.86 | 66.98 | 69.83 | 73.84 | 76.31 | 76.93 | 44.99 | 57.25 | 58.49 | 61.34 | 62.89 | 63.97 |
| Head (3) | 50.70 | 67.29 | 69.29 | 74.54 | 77.32 | 78.55 | 40.20 | 55.79 | 56.25 | 62.04 | 65.13 | 65.36 |
| Head (4) | 26.39 | 31.87 | 31.10 | 36.88 | 39.58 | 47.53 | 20.06 | 27.55 | 23.77 | 27.24 | 28.40 | 32.95 |
| Head (5) | 29.25 | 37.58 | 37.50 | 41.36 | 41.75 | 45.30 | 24.00 | 30.95 | 30.79 | 31.72 | 31.79 | 33.03 |
| Head and Hands (1) | 51.62 | 64.59 | 68.21 | 75.62 | 78.86 | 79.48 | 39.12 | 55.17 | 56.48 | 62.96 | 64.20 | 65.82 |
| Head and Hands (2) | 41.98 | 55.56 | 60.50 | 67.52 | 70.45 | 76.47 | 31.33 | 45.68 | 46.69 | 53.32 | 56.18 | 60.03 |
| Head and Hands (3) | 41.59 | 55.10 | 58.49 | 64.28 | 66.28 | 64.20 | 29.17 | 38.81 | 43.45 | 44.76 | 50.16 | 46.76 |
| Head and Hands (4) | 61.81 | 77.62 | 78.40 | 80.17 | 80.86 | 76.16 | 49.54 | 64.51 | 66.75 | 66.52 | 66.90 | 60.58 |
| Head and Hands (5) | 45.30 | 56.02 | 56.10 | 62.58 | 64.43 | 65.20 | 34.19 | 43.83 | 41.82 | 46.92 | 49.00 | 48.61 |
| Walking Motion (1) | 49.46 | 67.75 | 70.99 | 67.67 | 64.58 | 55.79 | 41.67 | 59.88 | 59.49 | 49.85 | 48.92 | 40.28 |
| Walking Motion (2) | 43.21 | 64.12 | 65.28 | 63.04 | 59.03 | 51.01 | 32.80 | 53.24 | 53.48 | 44.22 | 43.60 | 36.19 |
| Walking Motion (3) | 50.62 | 70.84 | 74.38 | 74.85 | 72.30 | 62.89 | 42.75 | 59.96 | 63.58 | 58.72 | 57.10 | 47.46 |
| Walking Motion (4) | 53.32 | 74.16 | 74.08 | 73.92 | 71.22 | 60.42 | 45.37 | 63.81 | 65.13 | 59.26 | 55.48 | 45.99 |
| Walking Motion (5) | 52.62 | 74.77 | 73.46 | 77.78 | 78.01 | 74.62 | 43.21 | 64.05 | 64.51 | 65.13 | 65.59 | 58.95 |
| Walking Motion (6) | 50.39 | 68.75 | 71.92 | 71.99 | 69.76 | 61.66 | 41.90 | 56.95 | 61.35 | 55.10 | 54.94 | 45.37 |
| Walking Motion (7) | 54.17 | 70.76 | 74.70 | 74.85 | 74.08 | 66.75 | 46.76 | 61.11 | 65.28 | 61.35 | 58.72 | 51.39 |
| Walking Motion (8) | 54.09 | 75.00 | 72.23 | 76.47 | 76.55 | 71.99 | 44.76 | 62.04 | 62.04 | 61.88 | 63.43 | 57.26 |
| | 150 cm | | | | | | 200 cm | | | | | |
| Motor noise | 54.02 | 71.61 | 71.22 | 70.60 | 69.29 | 63.74 | 49.93 | 61.96 | 64.51 | 59.72 | 59.80 | 53.94 |
| Right hand (1) | 48.69 | 63.20 | 63.97 | 61.81 | 61.42 | 55.25 | 43.36 | 53.17 | 54.17 | 49.00 | 51.70 | 47.07 |
| Right hand (2) | 38.97 | 55.40 | 53.32 | 48.23 | 49.08 | 45.83 | 31.79 | 44.29 | 42.13 | 36.11 | 38.89 | 34.26 |
| Right hand (3) | 47.30 | 61.73 | 62.04 | 58.80 | 58.57 | 52.94 | 41.82 | 51.86 | 53.24 | 46.53 | 48.69 | 44.99 |
| Right hand (4) | 45.37 | 60.50 | 60.58 | 58.64 | 60.50 | 55.79 | 41.05 | 48.46 | 51.08 | 46.46 | 50.62 | 45.68 |
| Right hand (5) | 47.46 | 59.96 | 60.34 | 58.34 | 59.42 | 55.02 | 42.59 | 49.69 | 51.70 | 47.15 | 48.69 | 44.37 |
| Left hand (1) | 41.20 | 54.48 | 57.95 | 56.10 | 57.18 | 54.71 | 35.19 | 45.84 | 47.84 | 44.75 | 47.76 | 45.76 |
| Left hand (2) | 35.80 | 46.92 | 47.92 | 46.45 | 48.30 | 47.61 | 30.56 | 38.12 | 37.89 | 35.88 | 38.43 | 36.81 |
| Left hand (3) | 46.53 | 58.80 | 60.88 | 58.72 | 58.87 | 54.86 | 40.05 | 49.54 | 51.16 | 46.68 | 50.00 | 46.15 |
| Left hand (4) | 27.63 | 38.74 | 38.35 | 41.82 | 42.90 | 42.83 | 21.07 | 27.86 | 28.47 | 30.79 | 32.33 | 31.33 |
| Left hand (5) | 41.82 | 55.94 | 57.41 | 56.49 | 57.80 | 53.78 | 36.50 | 46.76 | 47.46 | 44.99 | 48.46 | 45.53 |
| Both hands (1) | 37.50 | 53.40 | 53.71 | 50.31 | 53.78 | 50.46 | 31.72 | 43.06 | 44.06 | 40.67 | 43.91 | 41.44 |
| Both hands (2) | 39.82 | 51.78 | 52.47 | 48.15 | 52.32 | 47.53 | 31.87 | 42.67 | 42.52 | 37.43 | 40.82 | 37.81 |
| Both hands (3) | 36.50 | 49.46 | 50.62 | 48.54 | 50.16 | 45.99 | 30.56 | 38.74 | 40.43 | 36.65 | 38.89 | 37.12 |
| Both hands (4) | 37.27 | 51.24 | 52.09 | 49.31 | 51.39 | 48.61 | 31.71 | 41.51 | 42.98 | 37.35 | 41.05 | 39.28 |
| Both hands (5) | 40.82 | 53.86 | 56.33 | 52.01 | 52.63 | 49.39 | 34.80 | 44.68 | 45.84 | 41.83 | 43.21 | 40.74 |
| Head (1) | 22.61 | 33.95 | 32.48 | 32.80 | 35.96 | 37.43 | 16.59 | 23.84 | 22.46 | 21.76 | 23.84 | 25.16 |
| Head (2) | 37.58 | 48.23 | 49.31 | 51.62 | 53.71 | 51.62 | 32.57 | 42.28 | 42.83 | 42.05 | 44.75 | 42.91 |
| Head (3) | 33.26 | 47.76 | 49.15 | 51.93 | 53.47 | 53.48 | 26.93 | 39.74 | 39.59 | 40.43 | 43.99 | 44.60 |
| Head (4) | 14.82 | 21.69 | 17.21 | 20.45 | 20.76 | 24.31 | 12.58 | 17.52 | 14.74 | 15.90 | 16.13 | 17.98 |
| Head (5) | 18.91 | 25.85 | 25.47 | 24.77 | 24.85 | 25.39 | 16.36 | 20.61 | 21.53 | 20.06 | 21.38 | 21.22 |
| Head and Hands (1) | 33.03 | 45.99 | 46.37 | 50.16 | 53.09 | 53.32 | 27.93 | 37.97 | 38.27 | 39.90 | 43.67 | 43.52 |
| Head and Hands (2) | 23.54 | 36.81 | 35.65 | 42.29 | 44.14 | 47.53 | 18.91 | 29.86 | 28.78 | 34.11 | 36.04 | 39.67 |
| Head and Hands (3) | 20.84 | 28.40 | 31.72 | 32.64 | 35.57 | 36.04 | 15.97 | 21.68 | 21.84 | 21.38 | 25.23 | 24.31 |
| Head and Hands (4) | 41.98 | 54.09 | 56.02 | 51.62 | 53.71 | 50.16 | 35.42 | 43.98 | 45.37 | 40.05 | 43.37 | 41.75 |
| Head and Hands (5) | 25.54 | 33.80 | 32.10 | 34.57 | 36.73 | 38.04 | 21.22 | 24.77 | 24.15 | 24.70 | 25.85 | 27.63 |
| Walking Motion (1) | 37.11 | 50.16 | 48.77 | 37.12 | 38.82 | 30.56 | 30.87 | 40.43 | 38.35 | 27.47 | 26.16 | 17.06 |
| Walking Motion (2) | 27.78 | 43.98 | 40.59 | 31.56 | 32.80 | 24.54 | 21.92 | 34.49 | 31.33 | 21.07 | 21.38 | 13.74 |
| Walking Motion (3) | 34.11 | 50.31 | 52.32 | 43.52 | 45.68 | 37.42 | 30.25 | 41.28 | 42.90 | 32.87 | 34.96 | 25.23 |
| Walking Motion (4) | 38.20 | 53.17 | 52.63 | 43.98 | 44.45 | 35.73 | 32.64 | 44.99 | 43.06 | 30.02 | 33.65 | 24.39 |
| Walking Motion (5) | 37.66 | 54.56 | 53.63 | 51.70 | 51.55 | 48.08 | 32.33 | 45.30 | 45.53 | 41.20 | 44.29 | 37.58 |
| Walking Motion (6) | 33.42 | 47.22 | 46.99 | 41.21 | 42.44 | 35.11 | 28.32 | 38.35 | 37.27 | 28.78 | 31.17 | 24.31 |
| Walking Motion (7) | 40.28 | 51.01 | 53.32 | 45.84 | 47.38 | 40.67 | 34.11 | 44.06 | 43.13 | 35.50 | 36.73 | 29.40 |
| Walking Motion (8) | 36.03 | 51.62 | 52.09 | 49.08 | 50.54 | 45.45 | 28.86 | 41.90 | 39.90 | 36.27 | 41.13 | 33.18 |

TABLE 11
Isolated Word Recognition 3 (% Word Correct)

| Condition | J | | K | L | J | | K | L |
|---|---|---|---|---|---|---|---|---|
| | 50 cm | | | | 100 cm | | | |
| Motor noise | 85.27 | 0.03 | 83.34 | 83.41 | 79.48 | 0.00 | 79.48 | 80.79 |
| Right hand (1) | 83.18 | 0.00 | 81.64 | 82.72 | 75.78 | 0.00 | 76.85 | 77.86 |
| Right hand (2) | 80.87 | 0.00 | 79.79 | 81.72 | 72.54 | 0.00 | 71.61 | 74.23 |
| Right hand (3) | 81.87 | 0.00 | 82.56 | 81.64 | 76.54 | 0.00 | 76.39 | 76.47 |
| Right hand (4) | 83.41 | 0.00 | 83.10 | 82.80 | 75.23 | 0.00 | 77.01 | 76.93 |
| Right hand (5) | 83.80 | 0.00 | 82.18 | 82.41 | 75.85 | 0.00 | 76.00 | 76.70 |
| Left hand (1) | 81.95 | 0.00 | 82.10 | 81.95 | 73.23 | 0.00 | 75.47 | 76.62 |
| Left hand (2) | 78.55 | 0.00 | 78.46 | 79.48 | 68.29 | 0.00 | 69.37 | 71.99 |
| Left hand (3) | 83.72 | 0.00 | 84.01 | 82.41 | 74.62 | 0.00 | 76.01 | 76.93 |
| Left hand (4) | 78.78 | 0.00 | 77.55 | 79.48 | 68.75 | 0.00 | 68.60 | 71.22 |
| Left hand (5) | 82.03 | 0.01 | 81.48 | 82.41 | 74.00 | 0.00 | 74.93 | 75.54 |
| Both hands (1) | 80.79 | 0.00 | 79.78 | 80.33 | 71.84 | 0.00 | 72.53 | 73.77 |
| Both hands (2) | 78.94 | 0.00 | 78.94 | 80.33 | 69.14 | 0.00 | 69.75 | 71.61 |
| Both hands (3) | 78.40 | 0.00 | 79.86 | 80.40 | 67.67 | 0.00 | 69.29 | 70.76 |
| Both hands (4) | 78.78 | 0.00 | 79.17 | 79.79 | 69.83 | 0.00 | 69.44 | 71.30 |
| Both hands (5) | 81.41 | 0.00 | 80.17 | 80.33 | 71.22 | 0.00 | 71.99 | 73.46 |
| Head (1) | 70.76 | 0.00 | 70.30 | 74.15 | 58.57 | 0.00 | 58.10 | 63.27 |
| Head (2) | 75.16 | — | 74.54 | 78.01 | 65.97 | 0.00 | 65.90 | 72.77 |
| Head (3) | 75.93 | 0.35 | 74.00 | 78.48 | 67.21 | 0.00 | 66.13 | 73.07 |
| Head (4) | 51.39 | 0.00 | 51.08 | 56.87 | 41.67 | 0.00 | 40.59 | 47.76 |
| Head (5) | 50.23 | — | 50.24 | 57.41 | 42.83 | 0.00 | 44.45 | 48.23 |
| Head and Hands (1) | 77.32 | 0.74 | 76.16 | 80.63 | 67.59 | 0.01 | 68.90 | 73.84 |
| Head and Hands (2) | 71.22 | 0.86 | 70.06 | 77.47 | 58.49 | 0.00 | 58.57 | 68.91 |
| Head and Hands (3) | 70.61 | 0.00 | 68.75 | 75.24 | 56.33 | 0.00 | 57.18 | 61.89 |
| Head and Hands (4) | 81.56 | 0.00 | 80.71 | 80.87 | 70.76 | 0.00 | 72.92 | 73.31 |
| Head and Hands (5) | 73.61 | 0.64 | 74.15 | 77.86 | 62.43 | 0.00 | 63.28 | 69.14 |
| Walking Motion (1) | 76.39 | 0.00 | 75.47 | 76.78 | 64.43 | 0.30 | 65.74 | 64.90 |
| Walking Motion (2) | 73.61 | 0.01 | 73.23 | 75.08 | 60.81 | 0.00 | 61.88 | 64.74 |
| Walking Motion (3) | 77.62 | 0.00 | 77.32 | 79.32 | 68.36 | 0.00 | 68.83 | 69.14 |
| Walking Motion (4) | 79.17 | 0.07 | 78.86 | 78.24 | 69.06 | 0.01 | 70.99 | 70.29 |
| Walking Motion (5) | 81.10 | 0.00 | 78.48 | 80.94 | 71.69 | 0.00 | 72.30 | 75.47 |
| Walking Motion (6) | 76.93 | 0.00 | 76.70 | 78.17 | 67.13 | 0.00 | 68.13 | 67.75 |
| Walking Motion (7) | 79.17 | 0.01 | 77.55 | 79.56 | 70.22 | 0.00 | 71.22 | 72.30 |
| Walking Motion (8) | 79.94 | 0.00 | 79.40 | 80.17 | 72.15 | 0.00 | 71.92 | 73.77 |
| | 150 cm | | | | 200 cm | | | |
| Motor noise | 73.69 | 0.00 | 73.92 | 73.85 | 66.75 | 0.00 | 69.14 | 68.44 |
| Right hand (1) | 67.75 | 0.00 | 68.60 | 70.14 | 59.73 | 0.00 | 62.66 | 61.89 |
| Right hand (2) | 62.96 | 0.00 | 62.19 | 64.12 | 52.01 | 0.00 | 54.40 | 57.49 |
| Right hand (3) | 66.75 | 0.00 | 67.52 | 66.51 | 59.11 | 0.00 | 60.73 | 60.80 |
| Right hand (4) | 67.67 | 0.00 | 68.37 | 68.60 | 60.03 | 0.00 | 61.11 | 62.35 |
| Right hand (5) | 66.51 | 0.00 | 67.44 | 68.52 | 57.80 | 0.00 | 58.72 | 61.65 |
| Left hand (1) | 62.89 | 0.00 | 64.43 | 68.06 | 54.86 | 0.00 | 55.86 | 59.65 |
| Left hand (2) | 56.72 | 0.00 | 57.48 | 59.42 | 47.23 | 0.00 | 49.15 | 50.16 |
| Left hand (3) | 65.05 | 0.00 | 67.52 | 67.83 | 58.95 | 0.00 | 59.57 | 61.88 |
| Left hand (4) | 59.73 | 0.00 | 60.19 | 61.88 | 50.85 | 0.00 | 52.39 | 55.79 |
| Left hand (5) | 65.97 | 0.00 | 64.82 | 68.13 | 55.71 | 0.00 | 55.87 | 59.57 |
| Both hands (1) | 59.80 | 0.00 | 61.42 | 64.66 | 51.70 | 0.00 | 53.48 | 55.48 |
| Both hands (2) | 59.65 | 0.00 | 60.50 | 62.50 | 50.54 | 0.00 | 51.63 | 54.94 |
| Both hands (3) | 57.18 | 0.00 | 58.34 | 60.73 | 48.38 | 0.00 | 48.92 | 52.94 |
| Both hands (4) | 56.41 | 0.00 | 58.03 | 60.57 | 49.16 | 0.00 | 50.39 | 52.47 |
| Both hands (5) | 60.57 | 0.00 | 61.81 | 63.58 | 52.24 | 0.00 | 53.40 | 55.56 |
| Head (1) | 45.99 | 0.00 | 47.61 | 52.24 | 37.35 | 0.00 | 37.96 | 43.98 |
| Head (2) | 57.64 | 0.00 | 57.79 | 64.20 | 50.39 | 0.00 | 52.93 | 57.72 |
| Head (3) | 56.56 | 0.00 | 57.57 | 63.43 | 51.24 | 0.00 | 49.93 | 57.64 |
| Head (4) | 32.56 | 0.00 | 31.10 | 40.28 | 27.16 | 0.01 | 27.09 | 34.42 |
| Head (5) | 36.88 | 0.00 | 36.66 | 41.20 | 30.94 | 0.00 | 31.72 | 36.27 |
| Head and Hands (1) | 58.65 | 0.00 | 58.64 | 64.82 | 50.00 | 0.00 | 51.55 | 58.95 |
| Head and Hands (2) | 49.16 | 0.64 | 49.46 | 59.19 | 42.44 | 0.31 | 43.29 | 53.17 |
| Head and Hands (3) | 44.37 | 0.00 | 44.91 | 51.08 | 36.04 | 0.00 | 35.26 | 43.13 |
| Head and Hands (4) | 62.04 | 0.00 | 63.74 | 63.66 | 53.32 | 0.00 | 54.63 | 56.64 |
| Head and Hands (5) | 52.70 | 0.00 | 52.78 | 59.41 | 45.06 | 0.00 | 46.07 | 53.01 |
| Walking Motion (1) | 53.63 | 0.13 | 53.40 | 53.55 | 45.14 | 0.00 | 44.21 | 45.91 |
| Walking Motion (2) | 49.23 | 0.08 | 51.01 | 52.39 | 40.36 | 0.00 | 39.66 | 44.53 |
| Walking Motion (3) | 56.87 | 0.00 | 58.87 | 57.95 | 48.31 | 0.00 | 49.69 | 50.70 |
| Walking Motion (4) | 56.87 | 0.00 | 58.80 | 57.87 | 47.30 | 0.00 | 49.54 | 48.77 |
| Walking Motion (5) | 62.89 | 0.00 | 64.36 | 64.89 | 53.70 | 0.00 | 55.25 | 57.57 |
| Walking Motion (6) | 54.87 | 0.00 | 55.87 | 58.26 | 47.53 | 0.00 | 46.69 | 48.54 |
| Walking Motion (7) | 58.72 | 0.00 | 60.88 | 60.96 | 50.77 | 0.00 | 50.69 | 52.32 |
| Walking Motion (8) | 61.50 | 0.00 | 63.12 | 65.05 | 52.47 | 0.00 | 53.78 | 55.48 |

TABLE 12
Isolated Word Recognition 4 (% Word Correct)

| Condition | B′ | C′ | J′ | | K′ | L′ | B′ | C′ | J′ | | K′ | L′ |
|---|---|---|---|---|---|---|---|---|---|---|---|---|
| | 50 cm | | | | | | 100 cm | | | | | |
| Motor noise | 90.78 | 90.78 | 90.00 | — | 89.85 | 88.61 | 84.03 | 84.03 | 85.04 | 0.44 | 85.12 | 85.82 |
| Right hand (1) | 88.45 | 87.45 | 89.23 | 0.02 | 87.99 | 87.99 | 74.42 | 77.37 | 83.65 | 0.00 | 83.80 | 83.34 |
| Right hand (2) | 83.57 | 81.17 | 86.05 | 0.00 | 86.28 | 86.67 | 69.38 | 66.67 | 78.76 | 0.00 | 77.91 | 80.16 |
| Right hand (3) | 86.36 | 85.51 | 88.14 | 0.00 | 89.31 | 86.28 | 72.95 | 75.35 | 81.55 | 0.00 | 82.17 | 81.78 |
| Right hand (4) | 89.77 | 88.06 | 88.61 | 0.63 | 88.53 | 86.44 | 76.67 | 77.29 | 82.95 | 0.00 | 83.88 | 82.10 |
| Right hand (5) | 87.91 | 87.75 | 88.68 | 0.25 | 88.14 | 87.29 | 75.89 | 76.51 | 82.64 | 0.00 | 82.72 | 82.33 |
| Left hand (1) | 85.43 | 86.75 | 87.44 | 0.41 | 88.30 | 87.52 | 71.48 | 71.86 | 80.23 | 0.00 | 81.86 | 82.02 |
| Left hand (2) | 80.55 | 82.25 | 84.19 | 0.01 | 82.10 | 80.62 | 64.42 | 65.58 | 73.96 | 0.00 | 74.97 | 76.52 |
| Left hand (3) | 86.05 | 85.97 | 88.14 | 0.01 | 85.43 | 86.36 | 73.96 | 75.66 | 79.93 | 0.00 | 81.55 | 81.32 |
| Left hand (4) | 79.85 | 81.17 | 83.33 | 0.03 | 82.41 | 83.49 | 65.27 | 67.05 | 71.79 | 0.00 | 73.10 | 74.42 |
| Left hand (5) | 86.05 | 87.13 | 87.76 | 0.26 | 87.21 | 86.75 | 70.70 | 72.87 | 81.01 | 0.00 | 81.09 | 81.71 |
| Both hands (1) | 83.18 | 82.79 | 86.20 | 0.00 | 86.52 | 85.35 | 66.59 | 67.75 | 79.07 | 0.00 | 78.68 | 80.23 |
| Both hands (2) | 80.23 | 80.39 | 85.66 | 0.00 | 85.74 | 86.21 | 63.72 | 65.59 | 75.27 | 0.00 | 76.67 | 78.07 |
| Both hands (3) | 79.31 | 80.47 | 84.96 | 0.00 | 85.43 | 85.74 | 62.95 | 65.20 | 75.12 | 0.00 | 75.74 | 76.83 |
| Both hands (4) | 80.08 | 80.31 | 85.35 | 0.00 | 85.20 | 85.27 | 64.34 | 64.19 | 76.59 | 0.00 | 77.13 | 77.44 |
| Both hands (5) | 82.71 | 82.87 | 86.21 | 0.00 | 86.20 | 85.51 | 66.21 | 66.83 | 78.76 | 0.00 | 78.30 | 78.84 |
| Head (1) | 71.01 | 73.33 | 75.28 | 0.03 | 75.27 | 78.30 | 55.43 | 57.06 | 61.09 | 0.00 | 60.62 | 65.35 |
| Head (2) | 81.55 | 84.89 | 82.56 | — | 82.48 | 84.89 | 68.38 | 72.33 | 74.04 | 0.18 | 72.87 | 78.76 |
| Head (3) | 84.11 | 85.04 | 84.03 | — | 83.49 | 85.27 | 70.78 | 69.61 | 74.27 | 0.00 | 73.03 | 78.61 |
| Head (4) | 50.86 | 55.43 | 56.59 | 0.00 | 57.21 | 62.71 | 38.07 | 43.26 | 44.96 | 0.00 | 44.11 | 51.32 |
| Head (5) | 53.03 | 57.68 | 56.90 | — | 57.52 | 64.81 | 40.70 | 44.88 | 46.98 | 0.00 | 46.36 | 51.94 |
| Head and Hands (1) | 83.42 | 85.04 | 83.80 | — | 83.49 | 85.51 | 70.78 | 74.81 | 74.35 | — | 74.50 | 78.92 |
| Head and Hands (2) | 76.05 | 79.00 | 78.84 | — | 79.46 | 84.42 | 62.49 | 67.83 | 65.74 | — | 64.34 | 73.88 |
| Head and Hands (3) | 71.86 | 72.64 | 77.21 | 0.00 | 76.44 | 79.46 | 54.26 | 55.20 | 62.40 | 0.00 | 61.71 | 67.13 |
| Head and Hands (4) | 84.11 | 84.65 | 87.68 | 0.00 | 87.68 | 85.20 | 68.30 | 69.77 | 77.13 | 0.00 | 78.14 | 79.38 |
| Head and Hands (5) | 79.54 | 81.01 | 81.71 | 0.27 | 82.64 | 82.79 | 64.11 | 65.89 | 69.15 | 0.00 | 69.84 | 73.11 |
| Walking Motion (1) | 82.17 | 82.02 | 84.27 | 0.05 | 83.02 | 84.66 | 69.61 | 71.79 | 72.10 | 0.60 | 71.94 | 72.79 |
| Walking Motion (2) | 79.07 | 78.76 | 80.47 | 0.12 | 79.92 | 81.94 | 63.65 | 66.28 | 66.36 | 0.77 | 66.98 | 70.55 |
| Walking Motion (3) | 83.65 | 83.33 | 85.66 | 0.01 | 86.28 | 86.67 | 71.40 | 71.71 | 75.12 | 0.00 | 75.74 | 76.82 |
| Walking Motion (4) | 84.66 | 84.50 | 86.20 | 0.03 | 85.58 | 85.51 | 73.03 | 73.72 | 75.74 | 0.00 | 75.43 | 76.75 |
| Walking Motion (5) | 84.89 | 84.73 | 86.44 | 0.08 | 85.58 | 86.13 | 75.66 | 74.19 | 80.00 | 0.00 | 78.84 | 80.31 |
| Walking Motion (6) | 82.95 | 83.18 | 85.20 | 0.03 | 84.27 | 84.35 | 68.22 | 69.23 | 75.51 | 0.00 | 75.59 | 75.35 |
| Walking Motion (7) | 84.19 | 85.20 | 85.04 | — | 84.73 | 86.21 | 73.96 | 75.12 | 77.83 | 0.01 | 77.68 | 79.15 |
| Walking Motion (8) | 84.89 | 83.03 | 87.13 | 0.00 | 87.06 | 86.05 | 74.11 | 71.32 | 78.69 | 0.00 | 78.68 | 79.77 |
| | 150 cm | | | | | | 200 cm | | | | | |
| Motor noise | 71.48 | 71.48 | 80.78 | 0.00 | 80.08 | 79.15 | 61.09 | 61.09 | 71.86 | 0.00 | 72.41 | 72.87 |
| Right hand (1) | 60.78 | 62.25 | 72.64 | 0.00 | 74.04 | 73.96 | 50.55 | 52.02 | 66.05 | 0.00 | 66.75 | 66.51 |
| Right hand (2) | 53.95 | 54.11 | 67.83 | 0.00 | 66.67 | 68.14 | 44.73 | 42.95 | 55.12 | 0.00 | 57.68 | 59.46 |
| Right hand (3) | 60.16 | 61.47 | 72.02 | 0.00 | 72.10 | 71.48 | 50.62 | 51.48 | 63.03 | 0.00 | 64.11 | 64.19 |
| Right hand (4) | 61.17 | 62.48 | 73.88 | 0.00 | 74.19 | 72.79 | 51.94 | 54.27 | 65.66 | 0.00 | 65.04 | 66.36 |
| Right hand (5) | 60.39 | 63.49 | 73.26 | 0.00 | 72.72 | 73.80 | 50.78 | 51.40 | 64.88 | 0.00 | 64.11 | 65.04 |
| Left hand (1) | 58.84 | 58.45 | 69.30 | 0.00 | 69.46 | 72.40 | 48.22 | 48.22 | 60.08 | 0.00 | 61.40 | 63.88 |
| Left hand (2) | 51.01 | 51.71 | 61.09 | 0.00 | 61.63 | 63.80 | 40.54 | 40.70 | 50.70 | 0.00 | 52.17 | 53.33 |
| Left hand (3) | 60.16 | 60.62 | 71.48 | 0.00 | 72.25 | 73.26 | 48.92 | 53.49 | 61.86 | 0.00 | 63.41 | 65.35 |
| Left hand (4) | 51.94 | 54.19 | 60.93 | 0.00 | 61.01 | 62.95 | 41.47 | 42.64 | 52.79 | 0.00 | 52.33 | 55.66 |
| Left hand (5) | 56.98 | 57.21 | 71.17 | 0.00 | 69.77 | 72.79 | 46.51 | 47.99 | 59.46 | 0.00 | 59.77 | 63.57 |
| Both hands (1) | 55.51 | 54.81 | 65.74 | 0.00 | 65.35 | 68.29 | 42.71 | 43.33 | 55.20 | 0.00 | 56.75 | 57.52 |
| Both hands (2) | 52.72 | 51.71 | 65.27 | 0.00 | 65.66 | 65.81 | 42.41 | 42.64 | 55.97 | 0.00 | 55.58 | 58.84 |
| Both hands (3) | 49.54 | 52.02 | 61.94 | 0.00 | 62.40 | 64.88 | 38.84 | 41.94 | 52.41 | 0.00 | 53.41 | 56.67 |
| Both hands (4) | 49.46 | 52.33 | 61.16 | 0.00 | 61.79 | 64.73 | 39.77 | 41.01 | 52.48 | 0.00 | 53.49 | 55.97 |
| Both hands (5) | 53.95 | 53.02 | 64.73 | 0.00 | 66.28 | 67.29 | 43.49 | 45.12 | 56.90 | 0.00 | 57.06 | 59.62 |
| Head (1) | 40.47 | 43.95 | 48.37 | 0.00 | 48.92 | 53.72 | 29.31 | 32.56 | 38.68 | 0.00 | 38.84 | 43.64 |
| Head (2) | 56.83 | 59.38 | 63.33 | 0.00 | 64.81 | 68.06 | 48.30 | 50.55 | 56.59 | 0.00 | 57.21 | 61.01 |
| Head (3) | 57.75 | 55.97 | 63.41 | 0.00 | 63.49 | 68.92 | 47.60 | 46.90 | 56.75 | 0.00 | 56.28 | 61.47 |
| Head (4) | 28.53 | 32.79 | 35.51 | 0.00 | 34.89 | 43.10 | 22.09 | 27.06 | 27.99 | 0.15 | 27.45 | 35.59 |
| Head (5) | 30.85 | 35.59 | 37.83 | 0.03 | 37.37 | 42.56 | 23.57 | 29.07 | 32.95 | 0.00 | 33.10 | 38.38 |
| Head and Hands (1) | 57.68 | 61.47 | 63.26 | 0.01 | 63.18 | 69.23 | 46.28 | 51.40 | 54.35 | 0.00 | 54.50 | 59.85 |
| Head and Hands (2) | 50.93 | 54.89 | 56.05 | 0.42 | 54.73 | 61.24 | 41.94 | 45.97 | 48.07 | 0.06 | 48.61 | 54.27 |
| Head and Hands (3) | 41.01 | 42.02 | 47.44 | 0.00 | 47.29 | 52.87 | 29.07 | 31.24 | 38.69 | 0.00 | 38.61 | 45.27 |
| Head and Hands (4) | 55.27 | 55.66 | 67.29 | 0.00 | 67.21 | 68.14 | 44.34 | 47.21 | 57.99 | 0.00 | 59.07 | 60.31 |
| Head and Hands (5) | 51.32 | 51.01 | 56.98 | 0.00 | 56.59 | 62.02 | 39.31 | 41.16 | 49.07 | 0.00 | 48.69 | 54.11 |
| Walking Motion (1) | 56.67 | 59.69 | 58.92 | — | 58.30 | 58.61 | 45.35 | 47.29 | 49.07 | 0.08 | 48.29 | 49.54 |
| Walking Motion (2) | 49.69 | 52.25 | 52.87 | 0.29 | 54.27 | 56.67 | 39.46 | 40.62 | 43.80 | 0.00 | 44.03 | 48.22 |
| Walking Motion (3) | 57.29 | 56.83 | 63.26 | 0.00 | 63.65 | 63.41 | 46.51 | 47.06 | 53.34 | 0.00 | 54.42 | 54.03 |
| Walking Motion (4) | 60.93 | 59.61 | 62.95 | 0.00 | 63.18 | 62.10 | 49.77 | 47.83 | 53.96 | 0.00 | 54.04 | 53.95 |
| Walking Motion (5) | 62.25 | 60.47 | 69.15 | 0.00 | 68.68 | 69.77 | 52.10 | 51.01 | 58.45 | 0.00 | 58.45 | 61.40 |
| Walking Motion (6) | 56.28 | 56.21 | 62.48 | 0.00 | 62.10 | 63.18 | 44.65 | 45.20 | 52.33 | 0.00 | 52.17 | 53.10 |
| Walking Motion (7) | 59.07 | 59.77 | 64.58 | 0.00 | 65.82 | 66.05 | 48.76 | 50.16 | 56.21 | 0.00 | 55.58 | 56.13 |
| Walking Motion (8) | 60.62 | 55.97 | 67.29 | 0.00 | 67.68 | 70.08 | 48.07 | 46.82 | 56.28 | 0.00 | 57.37 | 58.76 |

6. Discussion

Spectral Subtraction (SS) has been considered to be an effective process in noise suppression; however, in ASR in which a multi-condition trained acoustic model is used, SS may enlarge the difference between the speech data at recognition and the speech data at training due to suppression of noise, which may lead to degradation of the ASR performance. In the experiments in this embodiment, in conditions B and D, ASR was carried out using the same multi-condition trained acoustic model, and in condition D, SS was also applied. It was confirmed by the experiments that SS, which should be effective for improving the ASR performance, adversely degraded the ASR performance when combined with a multi-condition trained acoustic model.

In this embodiment, in order to effectively utilize SS while using a noise-robust acoustic model such as a multi-condition trained acoustic model, the acoustic model was trained using the speech data to which SS had been applied. When comparing the results in such a condition E and the results in condition B in which a conventional multi-condition trained acoustic model was used, the ASR performance was better in condition E, which revealed that SS had effectiveness when used with a noise-robust acoustic model. The effectiveness of SS was specifically apparent at a distance of 200 cm at which the SNR was low, and approximately 8% improvement in the ASR performance for stationary noise.

In addition, in this embodiment, the distortion due to SS was suppressed by adding white noise after applying SS so that the ASR performance was improved. In conditions F to I, the magnitude of additive white was varied, and respective ASR results are shown. The most results in the conditions in which white noise was added show better ASR performance than the results in condition E in which white noise was not added, and thus it was confirmed that additive white noise suppressed spectrum distortion, thereby improving the ASR performance. However, it was not possible to unambiguously determine the specific magnitude of additive white noise (p value in Equation (15)) which optimally improves the ASR performance in any environments. When examining the results motion by motion, in the case of the noise due to motion of the head, greater magnitude of white noise resulted in better ASR performance. Most of the motions of the head last for a short period, and generate loud noise due to close position of the microphone when compared with the other motions. On the other hand, because noise suppression in SS is carried out using an average noise, the noise level of a short term noise is relatively low. It is believed that there are noise spikes whose magnitude is greater than that of the average noise in SS, and thus a large noise component remains even after subtraction. It is also believed that, in the case of the motion of the head, the remaining noise component was flattened by increasing the magnitude of the additive white noise, which led to improvement in the ASR performance.

In the case of the other kinds of noises, it was not possible to determine the optimum magnitude of the additive white noise; however, smaller magnitude of the additive white noise tended to exhibit better ASR performance as the distance was greater. As the distance is greater, SNR generally becomes lower and distortion becomes greater; therefore, it might be believed that a greater magnitude of the additive white noise results in better ASR performance. However, in an environment at a great distance, the noise signal is greater than the input signal; therefore, flooring of SS is effective. It is believed that, due to this flooring, generation of distortion is suppressed, and a high ASR performance was obtained without adding a large magnitude of white noise. It is also believed that better ASR performance can be obtained by taking into account not only the magnitude of spectrum but also flooring effect and duration of noise when determining the magnitude of the additive white noise.

6.2 Effectiveness of Using MFT

The results obtained in condition J, in which ASR was carried out using MFT after applying noise suppression process and white noise addition, exhibited better ASR performance, in almost all environments, than the results obtained in conventional condition, by which condition J is deemed preferable. In addition, the results obtained in condition J in which MFT was used exhibited better ASR performance, in almost all environments, than the results obtained in condition G in which MFT was not used, by which MFT is deemed effective.

In condition J, noise matching with the template noise was carried out by using the input signal which included both speech data and noise, and then estimated noise was obtained, whereas in condition K, it was assumed that noise signal was identified, and noise matching with the template noise was carried out by only using noise. In condition L, it was assumed that noise is known. Because conditions K and L were more idealistic than condition J, the results in conditions K and L exhibited better ASR performance than that in condition J. However, the ASR performance in condition J was similar to that in conditions K and L; therefore, the noise matching according to the proposed method are preferably effective even in the case in which speech data and noise are mixed. In the environment at a distance of 50 cm, some results in condition L exhibited worse ASR performance than that in condition J. In condition L, noise is known; however, the MFT mask in condition L is not necessarily an optimum mask to obtain accurate ASR results, because, in the mask producing method of this embodiment, greater weight is applied to peaks and valleys in the spectrum which are considered to be important for ASR, and the weight of less noise portions is increased, whereas the acoustic model is not necessarily trained by only using clean speech data. Accordingly, this mask producing method does not necessarily produce an optimum mask for any input signals. It is believed that, in some environments, the results in the known noise condition did not necessarily exhibit the best ASR performance when compared with that in the other conditions. However, overall, the ASR performance was improved by using MFT, and it can be said that the proposed mask producing method is effective.

In the proposed method, an acoustic model based on condition B is used because it was believed that a multi-condition trained acoustic model was effective with respect to stationary noise. More specifically, stationary noise generated by the robot is pre-recoded, and the stationary noise is added to speech data. Spectrum Subtraction (SS) is applied to the obtained speech data including noise, and, after adding white noise thereto, an acoustic model is trained using the final speech data. However, as shown in TABLE 5, the results in condition C exhibited better ASR performance than that in condition B in many cases. Accordingly, even in the proposed method, it may be possible to further improve the ASR performance using the acoustic model based on condition C, i.e., by training an acoustic model using speech data that include not only stationary noise generated by the robot but also motion noise.

6.3 Effectiveness of Proposed Method When Using Unsupervised MLLR

Even combined with unsupervised MLLR, it was confirmed that the results in proposed condition J′ exhibited better ASR performance than that in conventional condition C′. MLLR has been deemed to be an effective adaptation method for acoustic models, and MLLR improves ASR performance in many environments. This proposed method a noise adaptation method which can be combined with MLLR.

Many methods, in which multi-condition trained acoustic model and MLLR are combined, have been practically used. Based on the confirmed effect of combination with MLLR, it is believed that this proposed method becomes more advantageous when compared with conventional method by combining MLLR. We have developed software to enable a robot to perform presentations. In presentations, the audiences may present questions. In such a situation, an acoustic model will be on-line adapted during accumulation of communications with the audiences by combining unsupervised adaptation with the proposed method, and high ASR performance will be achieved. Similar situation may occur not only during presentation but also the case of a guiding robot; therefore, the proposed method is applicable to many situations.

What is claimed is:

1. A robot that recognizes speech of a person while performing predetermined motions or gestures, comprising:
a drive unit executing the motions or gestures;
a determination unit determining one of the motions or gestures being executed;
a speech recognition unit having at least two recognition algorithms including a multi-condition training algorithm; and
a switch unit selecting one of the recognition algorithms depending on one of the motions or gestures determined.

2. The robot according to claim 1, wherein the recognition algorithms include a maximum-likelihood linear regression.

3. The robot according to claim 1, wherein the recognition algorithms include a missing feature theory.

4. The robot according to claim 1, further comprising a noise template retention unit pre-recording noise that is generated during execution of the predetermined motions or gestures, producing a noise template, and retaining the noise template, wherein the noise template is applied to one of the recognition algorithms selected.

5. The robot according to claim 1, further comprising:
a pre-processing unit suppressing noise included in an input signal, and sending out an output; and
a noise addition unit adding white noise to the output from the pre-processing unit.
